(19) United States
(12) Patent Application Publication
(10) Pub. No.: US 2014/0142881 A1
(43) Pub. Date: May 22, 2014

(54) System and Method to Test and Certify Equipment for Regulatory Compliance

(71) Applicant: Martin Storm, Victoria (AU)

(72) Inventor: Martin Storm, Victoria (AU)

(73) Assignee: BMM INTERNATIONAL, INC., Las Vegas, NV (US)

(21) Appl. No.: 14/082,387

(22) Filed: Nov. 18, 2013

Related U.S. Application Data
(60) Provisional application No. 61/727,787, filed on Nov. 19, 2012.

(51) Int. Cl. G05B 19/418

(52) U.S. Cl. CPC G05B 19/41875
USPC 702/84

(57) ABSTRACT

A system and method to test and certify equipment for regulatory compliance. The system and method are particularly directed to testing, certification and approval of gaming equipment, including electronic gaming machines such as slot and video games as well as gaming systems such as player tracking, slot accounting, and progressive systems. The method and system are implemented between a gaming laboratory and a manufacturer and provide efficiencies to increase the speed and reduce the costs of approving tested equipment.

### RELATED APPLICATION INFORMATION

This application claims priority benefit from U.S. Provisional Patent Application Ser. No. 61/727,787, filed on Nov. 19, 2012, the entirety of which is incorporated by reference in the present Application.

### COPYRIGHT NOTICE

Portions of this disclosure contain material in which copyright is claimed by the applicant. The applicant has no objection to the copying of this material in the course of making copies of the application file or any patents that may issue on the application, but all other rights whatsoever in the copyrighted material are reserved.

### BACKGROUND

Systems and methods to test and certify equipment for regulatory compliance have traditionally been in use in a variety of industries. One such industry is the gaming industry where the manufacture and use of products is strictly regulated through a complex structure of laws and statutes that differ from state to state in the United States, as well as in the different Native American jurisdictions in North America, and in other countries around the world. An example of a set of regulations for which gaming equipment must be compliant is shown in version 1.00 of a document entitled “Electronic Gaming Equipment Minimum Technical Standards” published by the Alcohol and Gaming Commission of Ontario in December 2007, which is hereby incorporated by reference. Gaming products and equipment that are to be introduced to a jurisdiction must be certified and approved before they are permitted to be exposed for play to the public in any jurisdiction.

The compliance certification process and product approval for a gaming equipment manufacturer typically follow the product development process. The product development approval process consists of a number of steps that are fairly common across many industries where electronic or microprocessor based equipment is produced. These steps include: 1) analysis and assessment; 2) design; 3) development and 4) quality assurance testing; followed by, 5) compliance certification testing; and ultimately, 6) regulatory approval. Different organizations have different approaches to the steps in the process. For example, one organization may set up individual departments to handle each of the steps independently with interaction between the departments at the transition point between the steps so that feedback is provided at particular milestones for a product. Another organization may apply a team approach where a team of experts is set up to continuously work together providing substantive feedback across each and every step in the process.

In either case, once development has been completed and the product passes through the quality assurance step, it is ready to be evaluated by a testing laboratory for compliance testing. Compliance testing by a certified testing laboratory usually takes several weeks at a minimum depending on the complexity of the product being submitted. In the case when the product fails during compliance testing, the certification process may take significantly longer given the need to correct all non-compliant issues that are required for resubmission of the product for another round of certification testing. Resubmissions are costly to the gaming equipment manufacturer and delay the gaming equipment manufacturer from deploying the product to market in a timely manner.

Once compliance testing has been completed by the testing laboratory and the product has passed the jurisdictional regulatory requirements, a certification report is produced and provided by the manufacturer to the gaming regulatory body. The regulatory agency evaluates the report, may perform additional jurisdictional testing of the product and, if found satisfactory, approves the product for placement in the jurisdiction.

Gaming equipment manufacturers are highly incentivized to minimize resubmissions. Any efficiencies that can be achieved in limiting resubmissions reduces the cost of the certification process, but it also reduces the time period for getting product into the commercial marketplace. A faster certification directly translates into improved competitiveness and higher revenues.

Resubmission rates vary widely from industry to industry and company to company within an industry. For the gaming industry, gaming equipment manufacturers' performance varies widely. A relatively high rate of product compliance quality has an average submission rate in the range of 1.6-2.0. It is not unusual for a gaming equipment manufacturer to resubmit product to the testing laboratory multiple times before receiving an approval. The goal of the gaming equipment manufacturer is to receive approval on the first pass, thereby achieving a resubmission rate of zero or a submission rate of 1. Gaming equipment manufacturers and testing laboratories are constantly seeking ways to improve the certification process and reduce the time for approval.

### BRIEF DESCRIPTION OF THE DRAWINGS

For a better understanding of the present invention, and to describe its operation, reference will now be made, by way of example, to the accompanying drawings. The drawings show preferred embodiments of the present invention in which:

FIG. 1 shows a prior art system of electronic gaming machines connected to a network of the type developed, certified and approved for regulatory compliance;

FIG. 2 is a flow diagram of a prior art electronic gaming machine with component parts connected to a server;

FIG. 3 is a block diagram of a prior art process to test, certify and approve equipment for regulatory compliance;

FIGS. 4A-F show a process to test, certify and approve equipment for regulatory compliance where the testing laboratory provides input in staged compliance testing that occurs during the quality assurance subprocess, including sample checklists and documentation;

FIG. 5 shows a testing laboratory system for evaluating, testing and certifying equipment for regulatory compliance;

FIG. 6 shows a process to test, certify and approve equipment for regulatory compliance where the testing laboratory provides input in staged compliance testing that occurs during the quality assurance subprocess, including system components associated with the process;

FIG. 7 shows the components of a toolbox core module in a product testing and certification process;

FIG. 8 shows the components of a toolbox master container module in a product testing and certification process;

FIGS. 9-10 are listings of the major database files for a toolbox central database and descriptions;

FIG. 11 shows the components of a toolbox reporting module in a product testing and certification process;

FIG. 12 shows the components of a toolbox management module in a product testing and certification process;

FIG. 13 shows a representative item tracking record produced by a toolbox item tracking module;

FIG. 14 shows the components of a toolbox time tracking module in a product testing and certification process;

FIG. 15 shows the components of a toolbox invoicing module in a product testing and certification process;

FIGS. 16A-C show representative records produced by a toolbox regulator management module for internal information, general information and financial information;

FIG. 17 shows the components of a toolbox employee management module in a product testing and certification process;

FIGS. 18-19 show a representative listing of the major users of a toolbox employee management module; and

FIG. 20 is a block diagram of a process to test, certify and approve equipment for regulatory compliance where a separate, independent QA arm of the test lab performs and delivers all of the quality assurance work during the quality assurance subprocess steps.

### DETAILED DESCRIPTION OF THE INVENTION

The present invention will now be described more fully with reference to the accompanying drawings. It should be understood that the invention may be embodied in many different forms and should not be construed as limited to the embodiments set forth herein. Throughout the figures, like elements of the invention are referred to by the same reference numerals for consistency purposes.

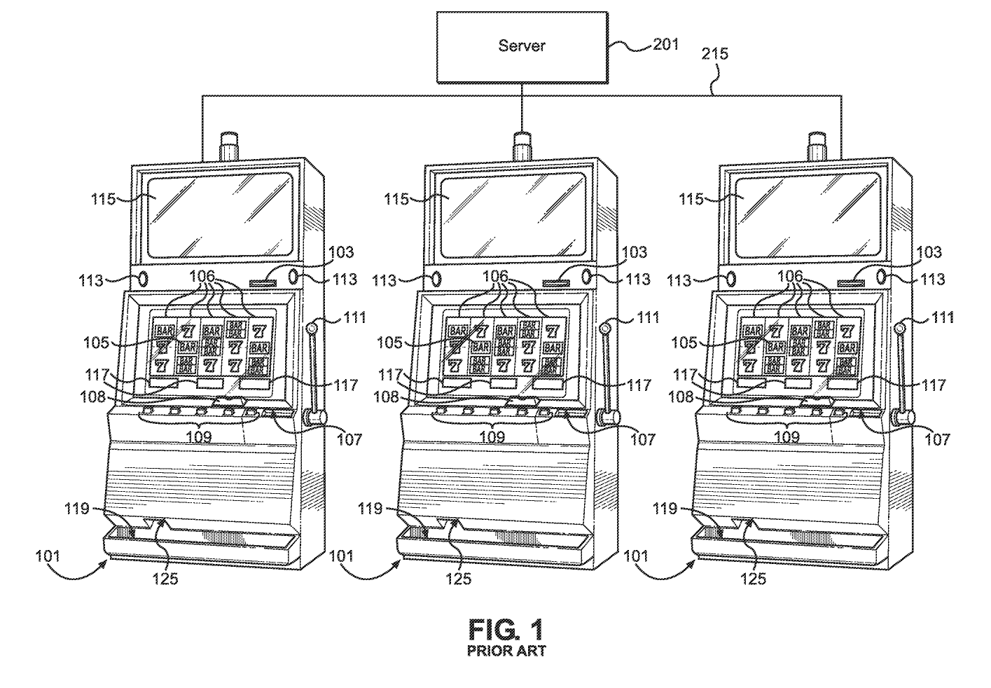

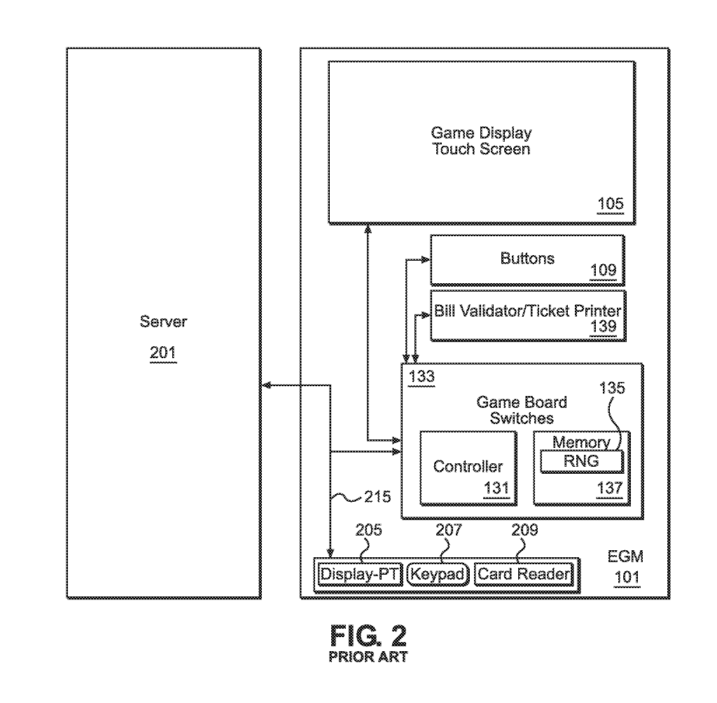

FIG. 1 shows a group of electronic gaming machines (individually “EGM” or together “EGMs”) 101 with a number of components. EGMs are one type of equipment typically developed by a gaming equipment manufacturer that is then tested and certified by a testing laboratory. EGMs may operate as a stand-alone device or in a network as shown in FIG. 1. Each EGM has a display 105 to show game play and resulting outcomes, and may be in the form of a video display (shown), or alternatively, physical reels. Touch screen displays are included on most EGMs and provide a flexible interface for operation of EGM 101, including displaying symbols 106 during play. Other components include a bill validator (see FIG. 2) and a coin acceptor that are both housed inside EGM 101 into which bills may be inserted through bill slot 107 and coins may be inserted through coin head 108, respectively. Buttons 109 on the exterior of EGM 101 are used to control certain EGM operations in conjunction with touch screen display 105. A handle 111 may be used to initiate play of a game and speakers 113 are used to provide sounds in conjunction with game play and other EGM operations. EGMs further include a top box 115 for displaying pay tables, artwork, advertising or other types of information either on fixed glass or on other displays such as an integrated video panel. Top box 115 may be fitted with a liquid crystal display (“LCD”) screen to permit aspects of game play from either a base game or a secondary game to be shown in top box 115. Meters 117 for tracking credits available for play, amount won on a particular play, number of coins bet, number of paylines played and other amounts are positioned near the bottom of screen 105. A coin tray 119 at the bottom of EGM 101 is used to catch coins as they are dispensed to a player through coin-out slot 125. It is also common for EGM 101 to include a ticket-in, ticket-out (“TITO”) component that may be part of the bill validator housed inside of EGM 101 that may accept bar coded credits through slot 107 and for which the value of the credits is displayed on meters 117 upon a ticket being inserted.

EGMs 101 may be connected to a network 215 that includes a server 201 that communicates with EGMs 101 for a variety of functions that may include administration of player tracking and slot accounting, customer loyalty programs, bonusing or other functionality and features.

FIG. 2 is a block diagram of EGM 101 connected to server based system 201 and showing certain internal components of EGM 101. All operational functions of EGM 101 are controlled by a controller 131 such as a microprocessor housed inside EGM 101 that is resident on a game board 133. The controller executes instructions that include operation of a random number generator 135 (“RNG”) that is usually implemented in software and stored in a memory 137. The internal components of EGM 101 are well known to those of ordinary skill in the art. Game outcomes are determined based on the results corresponding to the numbers selected by RNG 135. A bill validator 139 also has ticket printing capabilities (or a separate ticket printer may be included). Bill validator 139 accepts currency in the form of bills, or tickets from a player and adds credit to meters 117 on EGM 101.

Server system 201 such as a player tracking system, a slot accounting system or a bonusing system may also be connected to EGM 101. These types of systems are typically connected to EGM 101 either through a separate interface board (not shown) or directly to different components of EGM 101 including but not limited to game board 133. A player tracking system may also include other components installed on EGM 101 such as a player tracking display 205, a keypad 207 and a card reader 209. These components allow for direct interaction between server 201 and the player to receive information from the player on keypad 207 or through information on a card inserted into card reader 209, and to display information to the player on display 205. A network is established between external system 201 and EGM 101 by network connection 215. The network may be connected to all EGMs 101 in a casino, alternative gaming establishment or other venue that hosts gaming or any smaller subset of EGMs 101.

It will be understood that the type of network over which data is communicated can be one of several different types of networks. This includes a Local Area Network (LAN), Wide Area Network (WAN), an intranet or the Internet. Other proprietary networks could also be used without departing from the principles of the invention. This would include such networks as a Windows network or an Ethernet network.

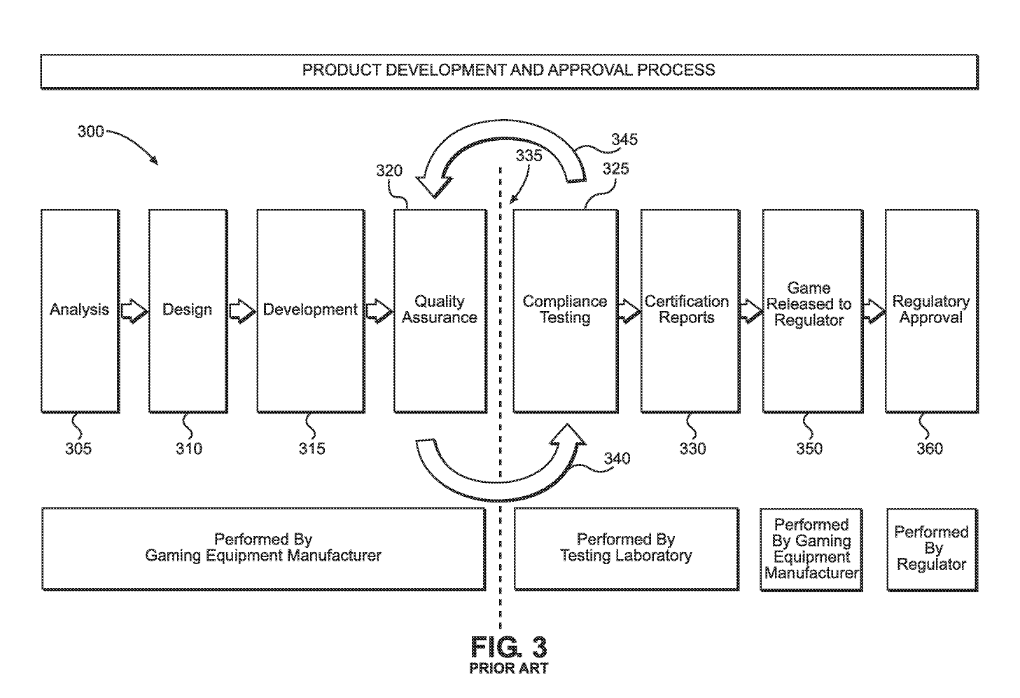

FIG. 3 is a block diagram of a prior art process 300 to develop, test and certify equipment for regulatory compliance to be able to place it for use into a jurisdiction. Process 300 has a number of steps that are performed by a gaming equipment manufacturer, a testing laboratory or a combination of the two. In a first analysis step 305, a gaming equipment manufacturer evaluates the requirements for a new or improved product. This includes assessing the markets to be served by the product, the regulatory requirements for those markets, available technology, cost of development and other factors influencing a decision to proceed with product development. From this effort, a set of functional specifications is prepared for the product to be developed.

Once the functional specification document is finalized, the gaming equipment manufacturer is ready to move to the second step 310 which is the design step. Design step 310 involves performing engineering design activities to develop a suitable functional design on which a new or improved product will be based. The functional specification is converted to a technical specification and the engineering organization identifies and determines the implementation of appropriate technology. Design step 310 also includes evaluating vendors to supply components, modules or other part configurations, a development timeline, a cost estimate and quality assessment.

Upon completion of a design plan, development of a product can begin to take form in development step 315. The development team takes the technical specifications and uses them to build the product. In development step 315, software is coded, hardware component designs may be prototyped (if applicable), and vendor products are evaluated for integration. A prototype is produced and tested to confirm that the design works and meets the technical and functional specifications.

After a prototype is produced and appropriately tested to ensure that it functions as designed, the prototype is turned over to quality assurance (“QA”) at step 320. QA takes the product and runs it though a series of tests for functionality, security, performance, and to ensure that it meets compliance with all regulations. Any issues found during QA step 320 are identified and categorized as critical or non-critical. Critical flaws are sent back to the design team or the development team for resolution which may require re-design or modification to the development program.

For each of analysis step, 305, design step 310, development step 315 and QA step 320, the process is performed exclusively by the gaming equipment manufacturer. However, once QA step 320 is completed, the product is provided to the testing laboratory and the performance of the process moves from the gaming equipment manufacturer to the testing laboratory.

The testing laboratory conducts its own compliance testing at step 325. Compliance testing involves testing the product for the specific requirements established by the jurisdiction in which the gaming equipment manufacturer intends to place the product for commercial use. If critical flaws are identified by the testing laboratory, the product is returned to the gaming equipment manufacturer for resolution, along with a report outlining the results of the testing so that the manufacturer may takes necessary steps to re-design, modify or otherwise revise the product to get into appropriate form to pass through compliance testing.

If the product passes compliance testing, a certification report is issued to the gaming equipment manufacturer at step 330 by the testing laboratory. A copy of this report is also typically provided to the agency within each jurisdiction that oversees the regulatory compliance of the equipment for that jurisdiction. The game is then released by the manufacturer to the regulators at step 350. The regulatory agency may then grant approval at step 360 so that the product can be exposed for play in that jurisdiction.

It should be understood that to date, development and approval process 300 has been performed with a “barrier” or “wall” 335 between the gaming equipment manufacturer and the testing laboratory. This barrier represents a division in the performance of the steps in the process between: 1) the gaming equipment manufacturer on the left side of line 335 for analysis, design, development and QA; and 2) the testing laboratory on the right side for compliance testing and certification reporting. The interaction between the manufacturer and the lab has been restricted to passing the product from the manufacturer to the lab after QA step 320 has been completed the first time through the process as indicated by arrow 340, and back from the lab to the manufacturer if a failure results at the compliance testing step 325 as represented by arrow 345. Once a failure has been corrected, the product is resubmitted by passing the product back to the testing laboratory a second time as represented by arrow 340. It is not unusual for a product to get passed back and forth from the manufacturer to the testing laboratory as indicated by arrows 340 and 345 a number of times before all compliance requirements are met. Throughout the process, it is not part of the standard routine for the testing laboratory to engage in the steps on the left side, or the manufacturer to participate in the steps on the right side of wall 335.

An important reason for maintaining the separation of steps between the gaming equipment manufacturer and the testing laboratory is to maintain the integrity of the testing laboratory as an independent entity whose testing and results are not subject to the influence of the gaming equipment manufacturer whose equipment is being tested. It is critically important that any new processes and systems implemented to increase efficiencies and enable faster, more cost-effective solutions to testing and certification for regulatory compliance maintain the integrity of the testing process. Otherwise, gaming patrons, gaming equipment manufacturers, gaming establishment operators, governmental agencies charged with regulatory oversight, the general public and other constituencies will lose trust in the process. This would severely damage the reputation of the gaming industry that has been largely built over the years on an established process that independently tests product to ensure the equipment operates as intended and as advertised, and that all testing is conducted fairly.

To date, regulatory compliance testing has been generally conducted as described with respect to FIG. 3 above. While this process has been effective, there are a number of steps that can be taken to improve the quality of the product, increase the efficiency of the process, reduce the time for products to reach the market and lower the costs of regulatory compliance testing, all while maintaining the independence of the testing laboratory. These desirable objectives may be achieved by enabling inputs of the testing laboratory in the specific step of quality assurance process 320.

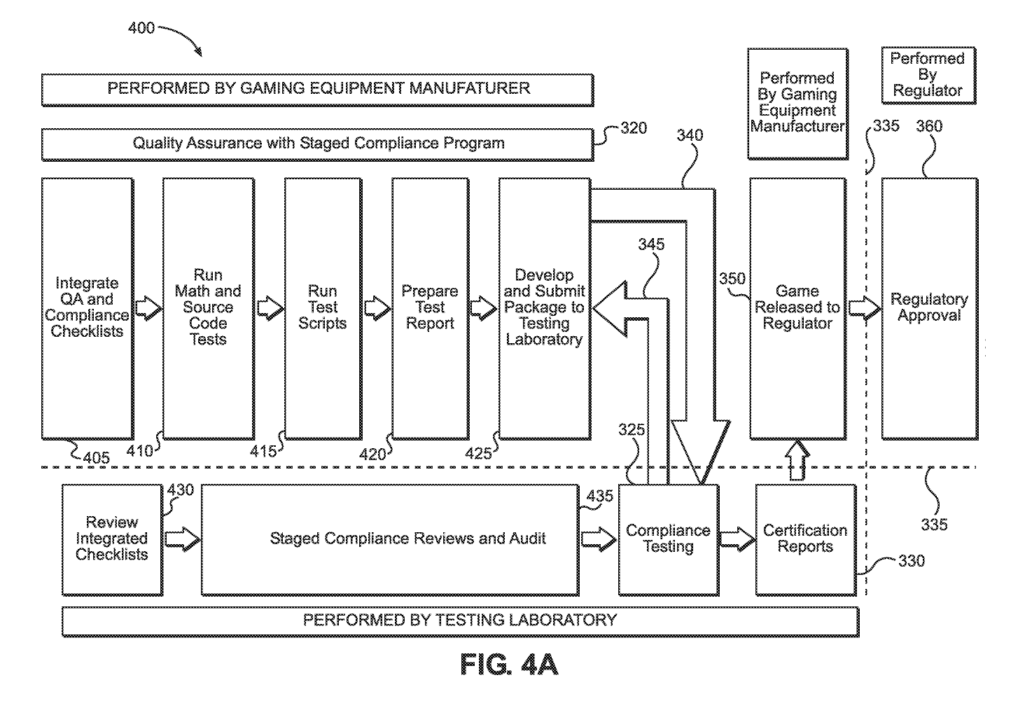

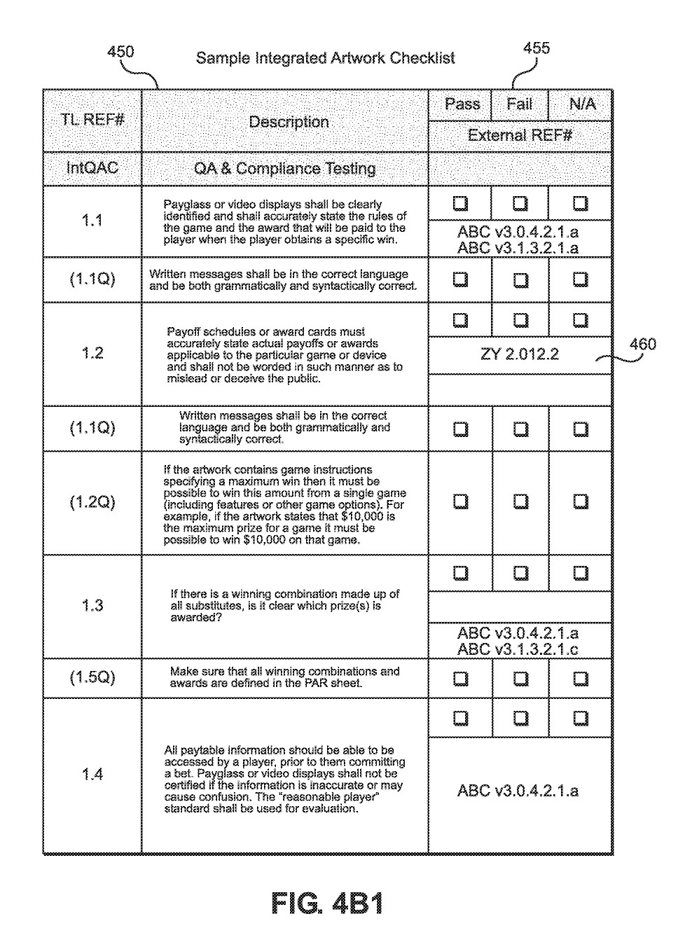

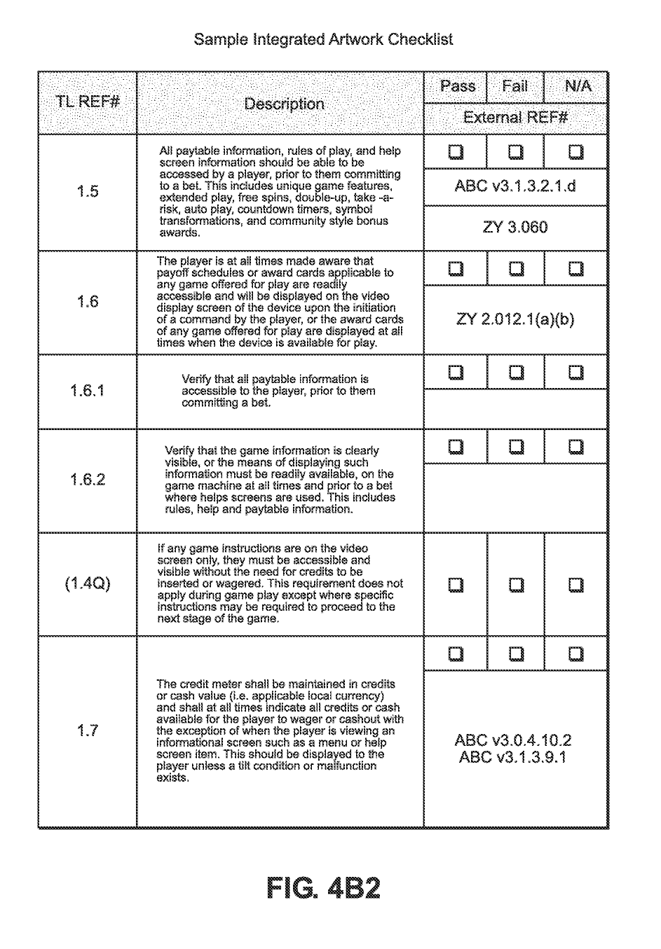

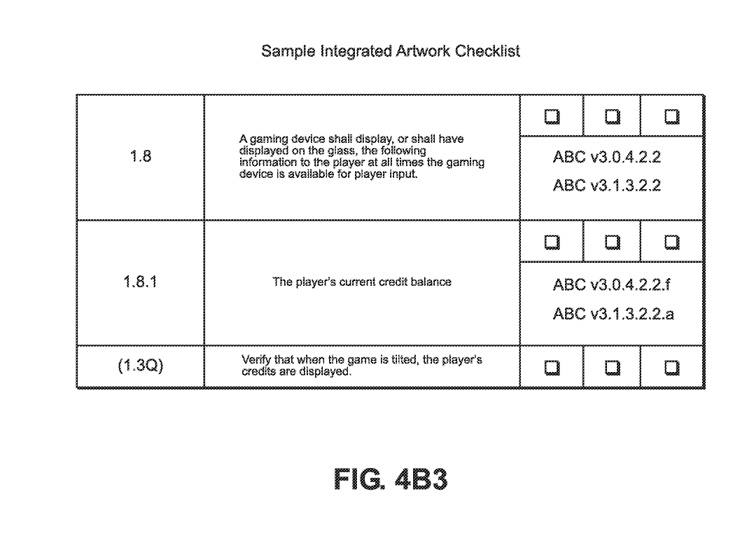

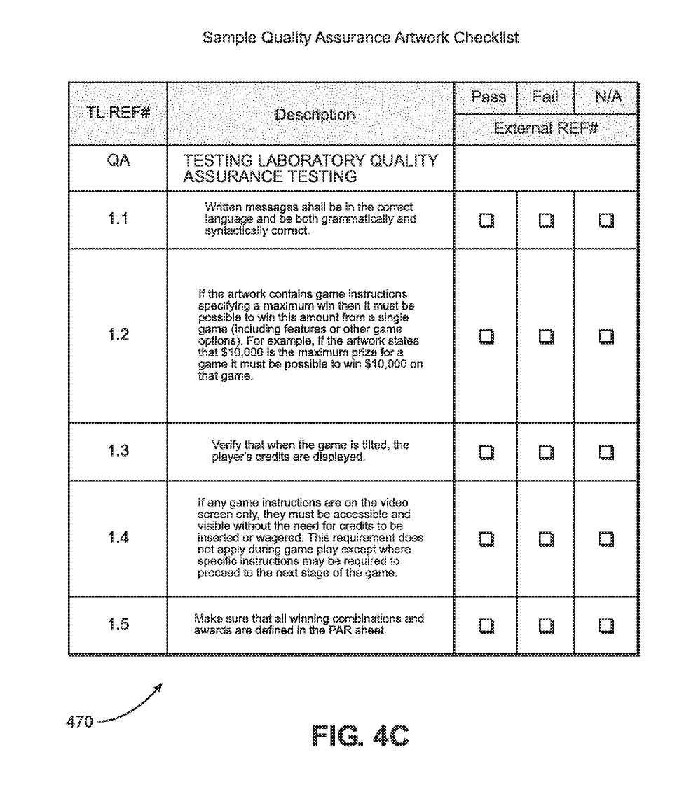

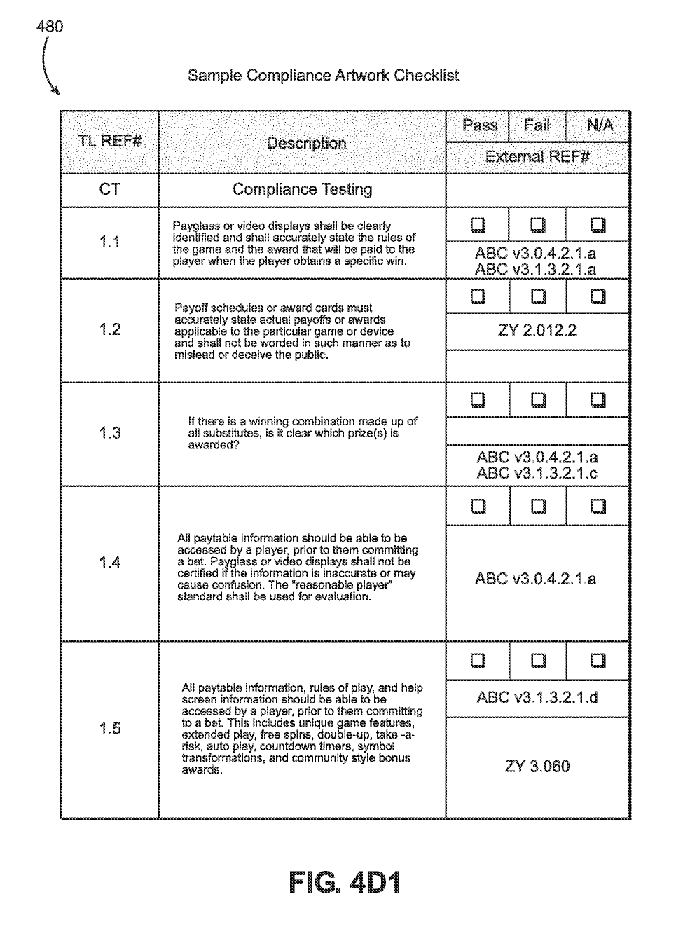

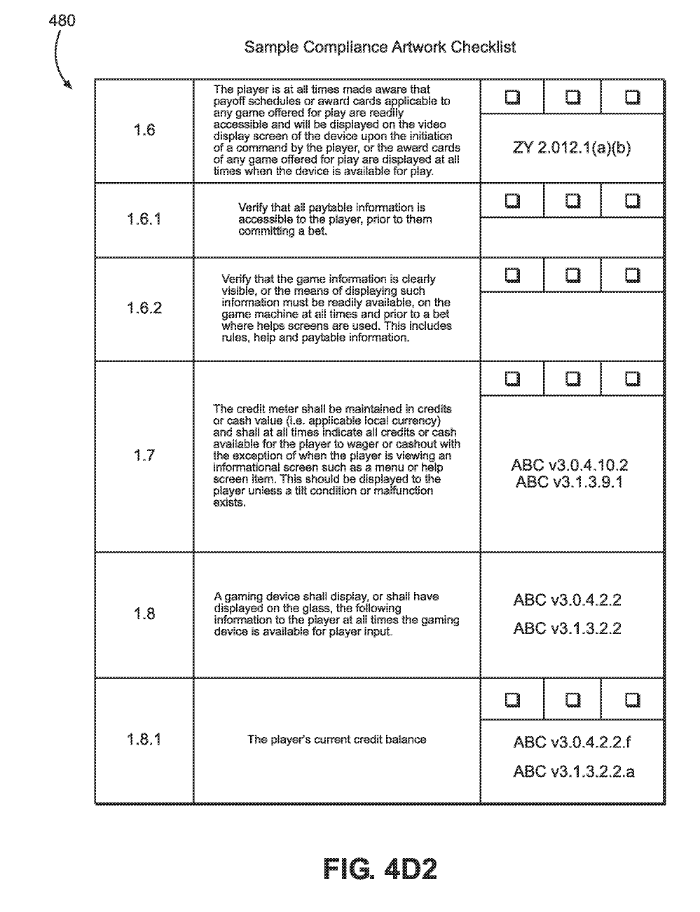

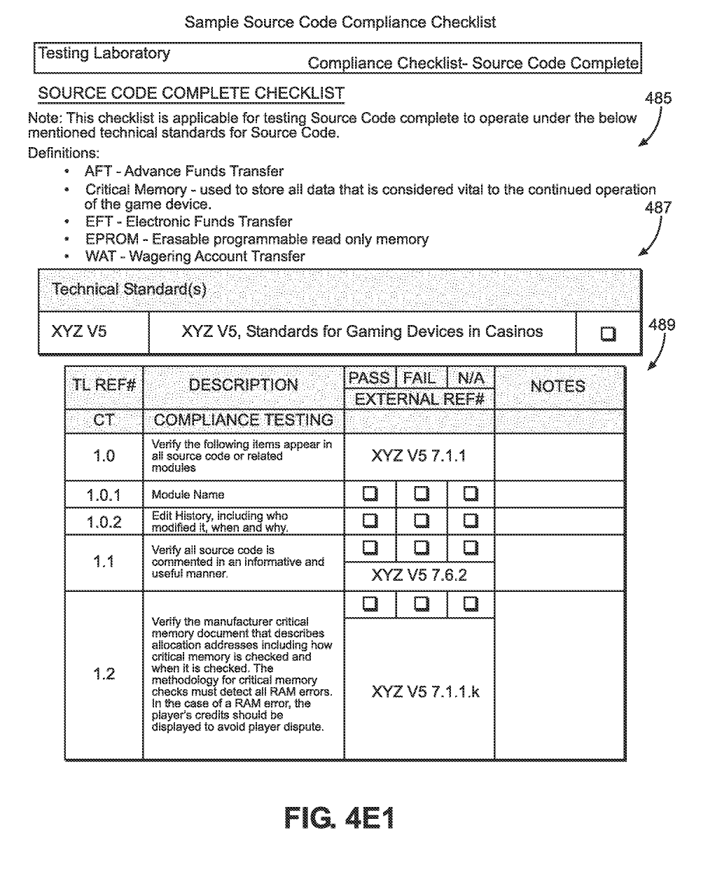

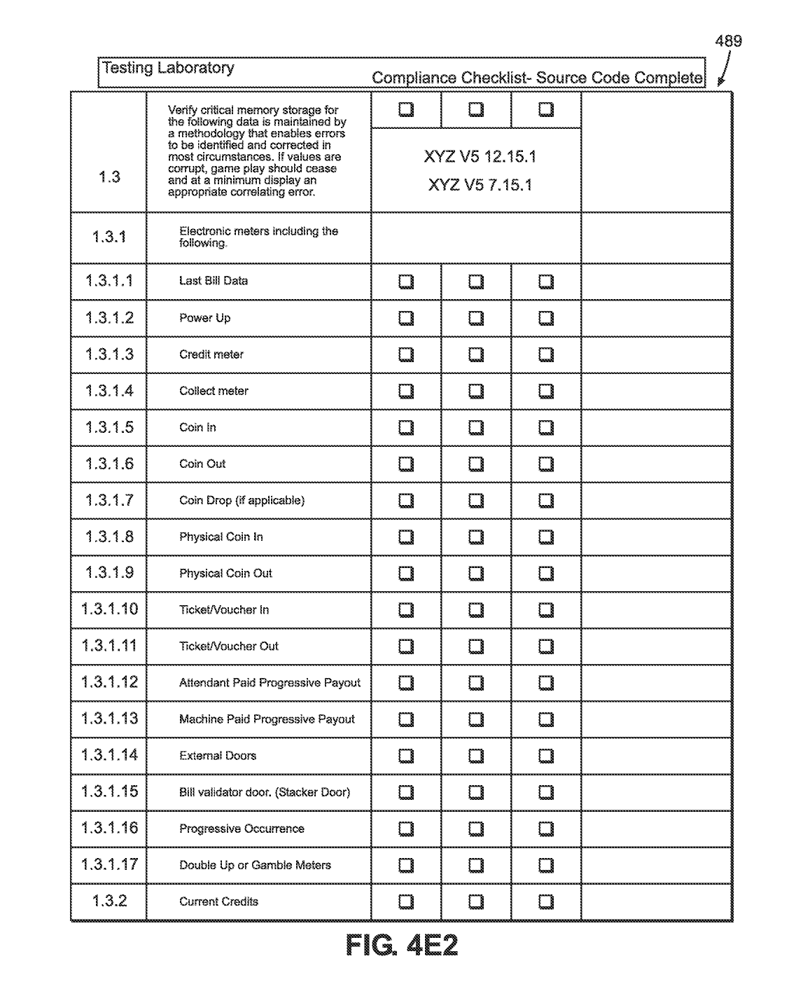

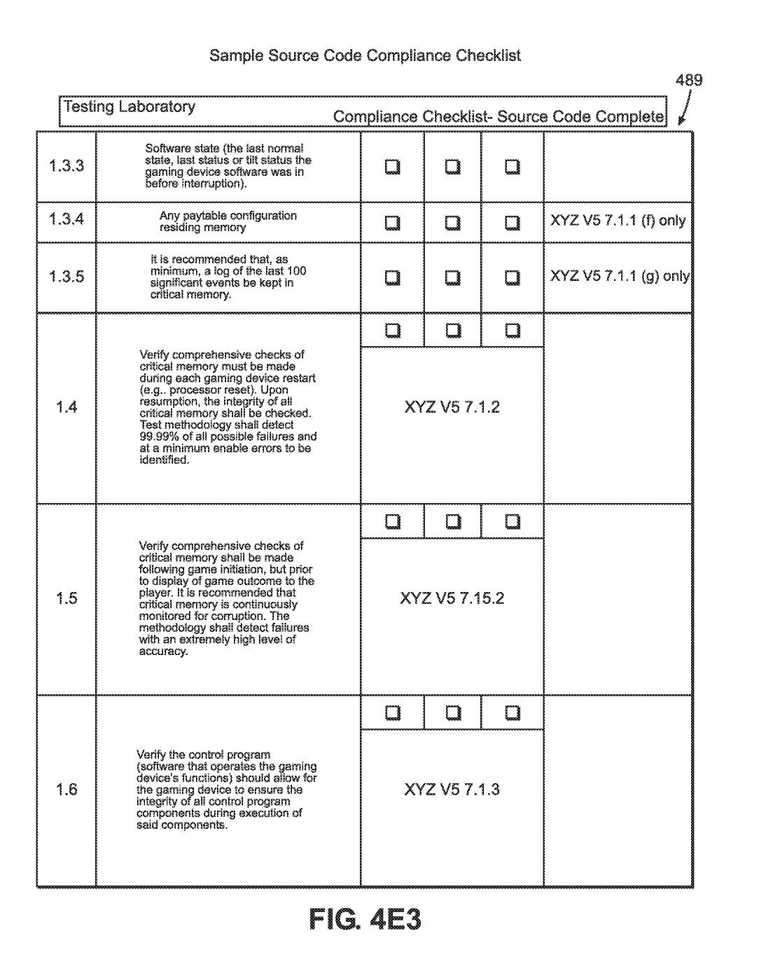

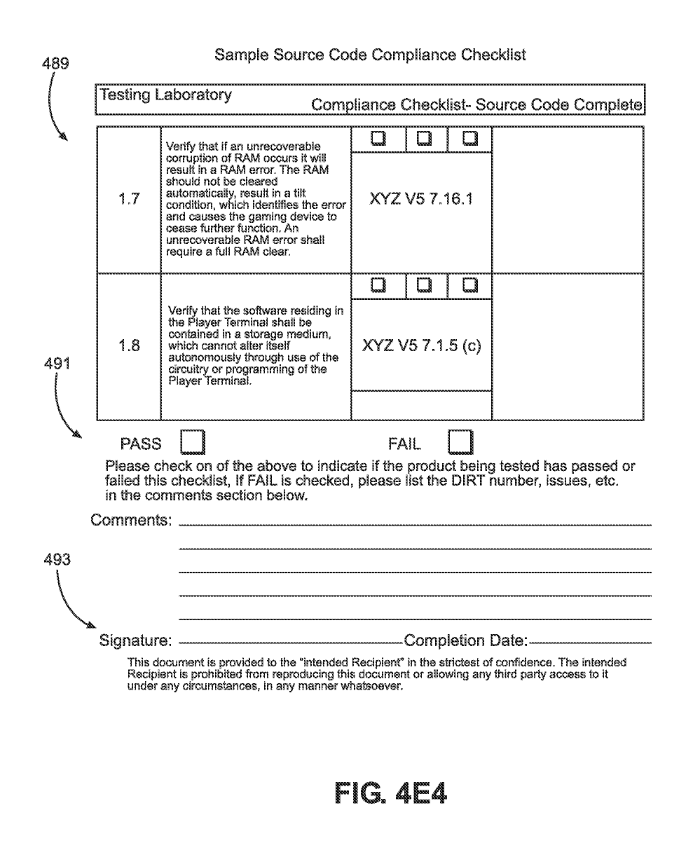

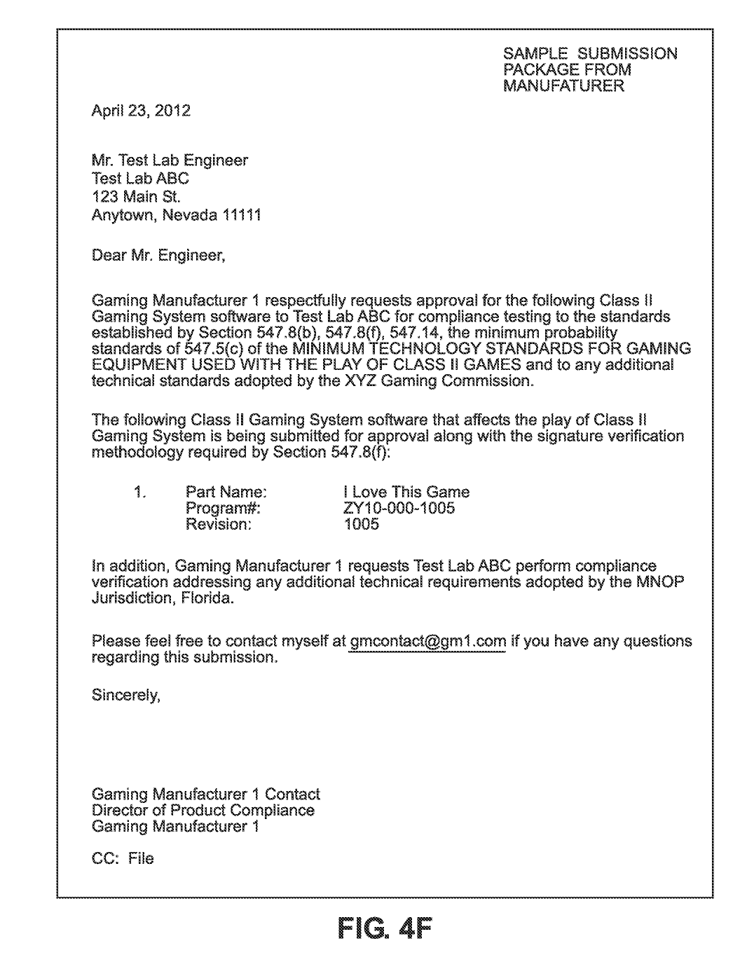

FIG. 4A shows a block diagram of a new process to test and certify equipment for regulatory compliance where the testing laboratory provides staged compliance testing across the quality assurance step 320 that follows product development before the final product testing step 325. In this newly established process 400, the testing laboratory provides independent feedback at the various substeps of the quality assurance step 320 above barrier 335 (between the equipment manufacturer and the testing laboratory) in two ways: 1) the testing laboratory provides input to the compliance testing elements needed for the gaming equipment manufacturer to develop an integrated QA and compliance checklist at step 430 and provides evaluation, tools, instruction and audits as part of staged compliance testing of the manufacturer's products 435; and 2) the testing laboratory then independently tests for compliance of the manufacturer's products 325.

The additional components of staged compliance testing where the testing laboratory provides input and reviews the manufacturer's checklists during quality assurance step 320 may include the compilation and confirmation of one or more integrated quality assurance and compliance checklists 405, tests that run math models and source code 410, the compilation and execution of test scripts 415, the preparation of test reports 420 and the development and submission of a complete standardized package to the testing laboratory 425 that will improve the efficiency of prior art process 300. The testing laboratory will review, analyze and approve integrated checklists and related testing methodologies 430 prior to the manufacturer executing the tests. The testing laboratory reviews and audits all the compliance testing performed by the manufacturer resulting in an audit report 435.

The particular tests to be run, for example in the case of EGM 101 may be to check the artwork displayed on the machine as outlined with respect to FIGS. 4B1 to 4B3 which shows a sample integrated artwork testing checklist. As can be seen from this document on the first page which is FIG. 4B1, a table 450 including a set of requirements is presented with a “Pass,” “Fail” or “N/A” (not applicable) check box 455 corresponding to each requirement. Also included is a space 460 for the applicable regulation to be indicated. In some instances, quality assurance tests may be systematically sequenced with the compliance tests to perform the required tests as efficiently as possible. The second and third pages, which are FIG. 4B2 and FIG. 4B3 respectively, include additional test procedures. It should be noted that table 450 includes a testing laboratory reference number (“TL Ref#”) for each entry in table 450 in the left-most column.

For compilation and confirmation of an integrated quality assurance and compliance checklist 405, the integration of the testing checklists start with the checklist used by the equipment manufacturer when performing their Quality Assurance (“QA”) testing. This QA checklist is reviewed with the checklist used by the testing laboratory for compliance testing and consolidated into a single checklist that combines both QA and compliance tests for the manufacturer. A sample QA checklist 470 and a sample compliance checklist 480 are shown in FIGS. 4C and 4D respectively, for the testing by the manufacturer (QA checklist) and the testing laboratory (compliance checklist) of artwork to be displayed on an EGM. QA checklist 470 has a number of items 1.1-1.5 that specify requirements for the display of artwork. In the past, the manufacturer used QA checklist 470 to ensure that it has met all requirements with respect to the design of the artwork to be displayed. Likewise, the testing laboratory used a separate compliance checklist 480 to ensure that the artwork met all regulatory requirements. This checklist is shown in FIG. 4D1-4D2 and includes much of the same information as QA checklist 470, along with additional testing to be handled by the testing laboratory.

During the process of consolidation, tests that are duplicated on both checklists are eliminated so the tests that are performed by the manufacturer are performed once prior to the testing laboratory tests in step 325. The sequencing of the QA and compliance checklists is aggregated. In that case, when QA and compliance testing are performed on the same areas of the cabinet or game, the integrated testing is much more efficient compared to when it is performed separately. The result is shown in the sample integrated checklists of FIG. 4B1-4B3.

The math and source code testing 410 of gaming equipment manufacturer software is a critical element of the compliance testing process. Math and source code testing is performed to verify that the game performs as intended. Some examples of the tests that are conducted to ensure that the game software complies are as follows: (a) testing of game rules; (b) testing the method of arriving at the game outcome through one or more random numbers from the RNG that determine the same reel stop positions; (c) testing for cheats or hidden functionality: (d) testing for functionality that could cause the game to behave outside of its intended use; and (e) a comparison of the par sheet (or paytable), game explanation and math in the source code to verify that the expected outcomes in the math matches the source code, that the defined payouts for the game match what is on the help screen, and confirmation of the specified payout percentage(s) to the player.

A sample compliance checklist for source code used in EGM 101 is shown in FIG. 4E, which consists of four pages labeled as corresponding FIGS. 4E1-4E4. As can be seen in FIG. 4E, a header section 485 includes a key to identify particular information such as “AFT” for advance funds transfer, Critical Memory, “EFT” for electronic funds transfer, “EPROM” for erasable programmable read only memory, and “WAT” for wagering account transfer. A technical standards box 487 is also included to identify the technical standard under which the source code is to be tested. Below header 485 is compliance source code testing checklist 489 similar to table 480 in FIG. 4D for artwork. The number of tests for checking source code is typically extensive and may run for numerous pages. Checklist 489 includes a listing of many tests run on source code for EGM 101 as shown on FIGS. 4E1-4E4. It should be understood that the list of tests shown in checklist 489 is only a sample and is not intended to be an exhaustive list of the tests to be run. A pass/fail check block 491 is shown near the end of checklist 489 on page 4 in FIG. 4E4 which is followed by a signature block 493 to be completed by the testing laboratory. Checklist 489 contains many individual tests to be performed on the source code.

As with checklist 480 for artwork, checklist 489 for source code is presented in a table format with a testing laboratory reference number (“TL REF #”) column. A description column includes an outline of the particular test to be performed. A “pass-fail-N/A” column includes checkboxes for pass, fail and not applicable, and also a space for identifying the particular regulation for which the test is directed. Finally, a “Notes” column is available for making notes.

The gaming equipment manufacturer is responsible for compiling the QA and compliance checklists into the integrated checklist and test scripts 405. The test scripts 415 are the specific tests and methodologies to be used to test a hardware or software component, which ensures that the product meets the functional and compliance requirements needed in order to place the product into the marketplace. The management of the testing laboratory then reviews this integrated checklist to ensure that required tests and methodology are included. This integrated checklist is approved by the testing laboratory prior to beginning the testing.

The gaming manufacturer performs the testing 410 and maintains records of each test performed in a checklist 415 and the outcome of each test is prepared in a test report 420. The testing outcomes may be pass/fail or a numerical result. The results are documented on the integrated checklist. Any issues that arise are documented on the checklist as well. Issues may be associated with how and what test is run, a concern about how a regulation was interpreted, any defects encountered that may or may not affect the product's approval status and other information that may be helpful in the process of the compliance testing at the testing laboratory. This checklist is the main part of the test report and is submitted to the testing laboratory as part of the submission package in step 425.

When a gaming equipment manufacturer submits a product to a testing laboratory for compliance testing 425, there is a standardized package that is provided to the testing laboratory that includes, but is not limited to: (a) identification of the product(s) to be tested; (b) documentation outlining the expected performance of the product; (c) a list of the jurisdictions for which the gaming equipment manufacturer is seeking approval; (d) a set of key contacts at the equipment manufacturer to whom questions may be directed, etc.; and (e) any other pertinent information that will assist the testing laboratory in streamlining the efficiency of the testing. By augmenting the results of the staged compliance testing performed by the gaming equipment manufacturer with reviews or audits by the testing laboratory that evaluates the testing being performed, the work by the testing laboratory to perform the independent tests at step 325 is more efficient. This is because the testing laboratory starts its own independent testing having familiarity with the product and with an expectation of product performance. A standardized package submission document would include one or more integrated checklists like the sample checklist shown in FIG. 4B1-4B3. The integrated checklist is completed by the manufacturer along with a cover letter explaining the request for approval and including identification information for the manufacturer, the jurisdiction in which approval is sought, the particular regulations of the jurisdiction for which compliance testing is to be performed, information related to the product to be tested, and any other information that the manufacturer includes to ensure that the testing laboratory understands the request and can perform suitable testing. A sample of such a letter is shown in FIG. 4F.

The process outlined where the gaming equipment manufacturer provides testing results to the testing laboratory for the staged compliance testing portion of the QA substeps shortens the time for products to reach the market thereby increasing revenue and profits for the gaming equipment manufacturer. It also reduces costs because rework efforts are handled more efficiently saving time and money, including labor efforts on the part of employees of the gaming equipment manufacturer. Forecasting of product release times is also more dependable because the gaming equipment manufacturer and the testing laboratory while working independently are following a similar process, and information is incorporated into the testing performed by the gaming manufacturer at the early stages with a single transfer of responsibility after the quality assurance and staged compliance testing is complete.

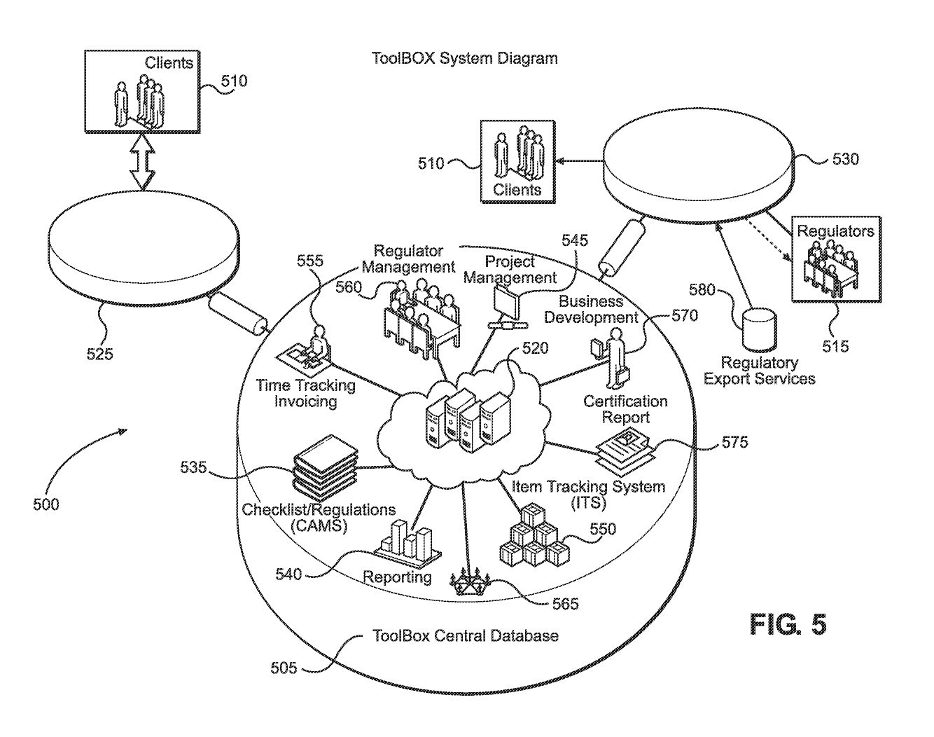

To support process 400, a system 500 shown in FIG. 5 is securely operated and maintained by the testing laboratory. System 500 is networked between a number of different parties including the testing laboratory, gaming manufacturers and other clients 510 of the testing laboratory, and governmental regulators 515. The toolbox is accessible to the testing laboratory employees through a client application system to toolbox central database 505 which has multiple modules that perform a number of different tasks to streamline the process from accepting a submission letter to producing the final certification report for testing projects received and completed. For example, toolbox 505 captures, stores and analyzes metrics including costs, productivity, cycle time and quality, and serves as the primary interface to the employees of the testing laboratory.

Toolbox 505 runs on one or more servers 520 at the center of system 500. The servers 520 may be dedicated servers located at the facilities of the testing laboratory, or they may be located remotely accessed by the testing laboratory over a network. Servers 520 may also be servers available for lease in whole or in part through a cloud based service such as that offered by Amazon.com or other operators of server farms.

It will be understood that the type of network over which data is communicated can be one of several different types of networks. These networks include a Local Area Network (LAN), Wide Area Network (WAN), an intranet or the Internet. Other proprietary networks could also be used without departing from the principles of the invention. This would include such networks as a Windows network or an Ethernet network.

Toolbox 505 has a number of modules that are shown in FIG. 5 and described as follows.

A jurisdictional approval reporting module (“JARS”) 525 for gaming equipment manufacturers that is accessible over a secure network so that the gaming equipment manufacturer(s) may submit projects to the testing laboratory as well as track and manage those projects through to approval. The submission of a new project involves entering a new product type or name with other information related to the product such as a list of product components, a list of jurisdictions where the manufacturer is seeking approval, corresponding technical documentation, and documentation of any prior history of testing performed by this or any other testing laboratory.

An online approval technology module 530 that maintains a database of certification/recommendation letters and evaluation reports, regulatory approvals, revocations and field verifications. Online approval technology module 530 is a web based application which provides secure access to any certification letters and data related to a specific licensing agency, manufacturer, or gaming operator. Upon successful completion, each project has a record stored in online approval technology module 530 which provides the data described above.

A compliance administration management module (“CAMS”) 535 for supporting technical compliance by maintaining a database of regulatory requirements and testing laboratory checklists. Management and maintenance of the repository is securely controlled by access levels, and user accounts.

A toolbox report module 540 for reporting project metrics such as the estimated versus actual costs and time charged against the estimate. Toolbox report module 540 is designed to generate all reports for toolbox 505 except for certification reports, which are generated from certification report module 575.

A project management module 545 for managing testing laboratory projects, completion of quality assurance and certification of gaming equipment. Project management module 545 is designed to control project information by providing users with the capability to add and edit project information. In addition, there are controls which enable the user to keep track of the historical project progression and document irregularities. Each project is assigned a code which is directly related to a specific manufacturer or regulator. Additionally all projects may be separated by region and location for better management yet remain available to all users who are granted the appropriate access level.

An item tracking system module 550 for tracking and storing any components or software received from external sources (clients, regulators, etc.). Item tracking system 550 keeps track of the locations of all physical items received on the premises such as product samples. Item tracking system 550 tracks any actions taken with an item and provides information on the current status or historical activity associated with the location of the item.

A time tracking and invoicing module 555 for tracking the time of testing laboratory personnel and other expenses associated with a particular project that may be invoiced to a client. Time tracking and invoicing system 555 provides the user with the ability to track time spent on specific tasks and document detailed information regarding the task. Time tracking and invoicing module 555 works in conjunction with project management module 545, business development module 570, and employee management module 565. The primary purpose of time tracking and invoicing system 555 is to provide data for final invoicing and metrics related to costs, productivity, cycle time and quality.

A regulator management module 560 that houses regulator contact and licensing information including licensing fees, the status of the license and renewal dates. Regulator management module 560 manages profiles of the licensing agencies for which the testing laboratory holds or is in the process of being granted a license, and provides alerts when licensing deadlines require action. The entries in regulator management module 560 are used to provide data for a number of other modules such as project management module 545 which requires the information for reporting and accurate management of a project. In addition, regulator management module 560 ensures that licensing for a specific jurisdiction recognizes the testing laboratory's certification reports for compliance testing and approval.

An employee management module 565 is used for managing testing laboratory employee data related to user accounts, access levels and billing information. Employee management module 565 provides data to project management module 545, and time tracking and invoicing module 555.

A business development module 570 manages current and potential new business opportunities being pursued by a testing laboratory. It has the capabilities to manage and maintain the database of all client relations, contact information and business relations. In addition, this database is used in project management module 545, time tracking and invoicing module 555, item tracking module 550, and toolbox report module 540.

A certification report module 575 that provides product assessment and certification reports and transfer letters for cross-jurisdictional approvals between one jurisdictional authority and another. To accomplish these tasks, certification report module 575 houses standardized report templates and imports data from project management module 545 and business development module 570.

A regulatory export services module 580 is a system designed for regulators that require scheduled exports of project related certification report data (but not the actual certification report itself).

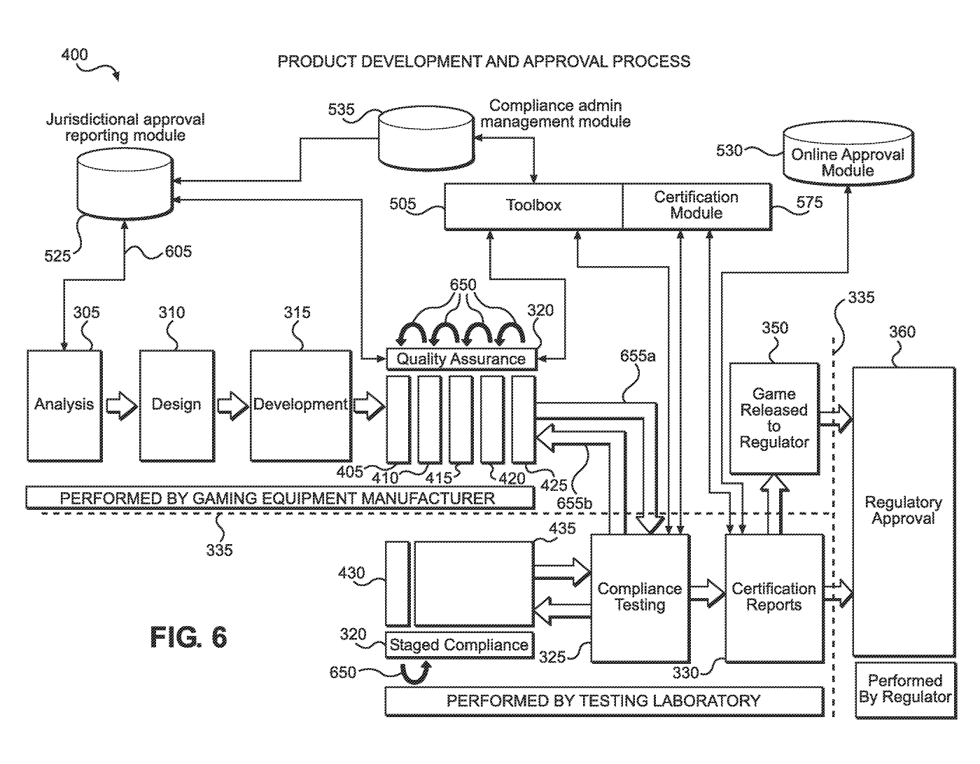

FIG. 6 is a block diagram of a process to test and certify equipment for regulatory compliance where the testing laboratory is able to provide compliance information and feedback in the quality assurance subprocesses, and showing system components associated with the overall process. As discussed with respect to the block diagram of FIG. 4, the testing laboratory and the gaming equipment manufacturer interact during the quality assurance process and the individual subprocess steps 405-425 making up quality assurance process and staged compliance steps 320 performed by the manufacturer and testing laboratory respectively. In addition, FIG. 6 shows the points in the process where the applications running on system 500 access toolbox 505, jurisdictional approval reporting module 525, compliance administration management module 535, online approval technology 530 and certification report module 575.

As discussed with respect to FIG. 3, a gaming equipment manufacturer performs analysis for a new product at step 305. During this analysis phase, the gaming equipment manufacturer may begin to utilize system 500. This occurs through the use of jurisdictional approval reporting system 525 which is represented with an access line 605. A gaming equipment manufacturer that is a subscriber to this service is able to access compliance administration management tool 535 through the jurisdictional approval reporting system 525, and is able to review the compliance criteria to incorporate any jurisdictional requirements into the analysis of the product at the time the design is being assessed. After the gaming equipment manufacturer completes the analysis step, design and development takes place at steps 310 and 315.

At quality assurance and staged compliance step 320, the testing laboratory becomes actively involved in the process at each substep 405-425 as described with respect to FIG. 4. As can be seen, the gaming equipment manufacturer (also referred to as “client”) may have its testing reviewed and audited by the testing laboratory through each substep 405-425 of the staged compliance portion of the quality assurance step 320. The handoff of responsibility in the process at barrier 335 remains so that the testing laboratory can conduct independent compliance testing. However, the earlier staged compliance testing steps of the QA process conducted by the gaming equipment manufacturer are performed as directed by the testing laboratory. The ongoing feedback via reviews and audit of QA and staged compliance step 320 and substeps 405-425 will also lead to more streamlined and efficient testing at step 325 and will reduce the amount of exchanges in compliance testing step 325 as indicated by submission and resubmission arrows 655a and 655b.

During QA and staged compliance step 320, the testing laboratory and the client access toolbox 505. At QA step 320, toolbox 505 provides the client with the ability to input the project parameters, track the progress of testing through the QA process and gain status of the test projects submitted. The testing laboratory may also access toolbox 505 at QA step 320. The transparency with the client at this step allows the testing laboratory to review prior notes and deficiencies that the manufacturer has uncovered during their testing, and be able to determine if the required corrections have been made satisfactorily using toolbox 505 and to provide feedback to the client for each substep 405-425 during reviews and audits. The testing laboratory and the client may also access jurisdictional approval reporting module 525 at QA step 320. This allows the client to formally submit the project to the testing laboratory for certification testing and the testing laboratory to receive the electronic file of the tests performed and the corresponding results achieved by the client.

When toolbox 505 is accessed by either the client or the testing laboratory during the QA step 320, compliance administration management module 535 is checked by toolbox 505 to determine applicable regulatory requirements and testing laboratory checklists.

Once quality assurance 320 and compliance testing 325 have been completed, the process continues as in the past with certification reports, submission and regulatory approval being handled at steps 330, 350 and 360, respectively. These actions are handled by online approval technology 530 and toolbox certification report module 575 which are each accessed to develop the certification report and to load the approval letter into online approval technology 530 which is then made available to clients and regulators through both a push and/or pull arrangement depending on each jurisdiction's regulatory requirements for notification of product that has been tested and certified.

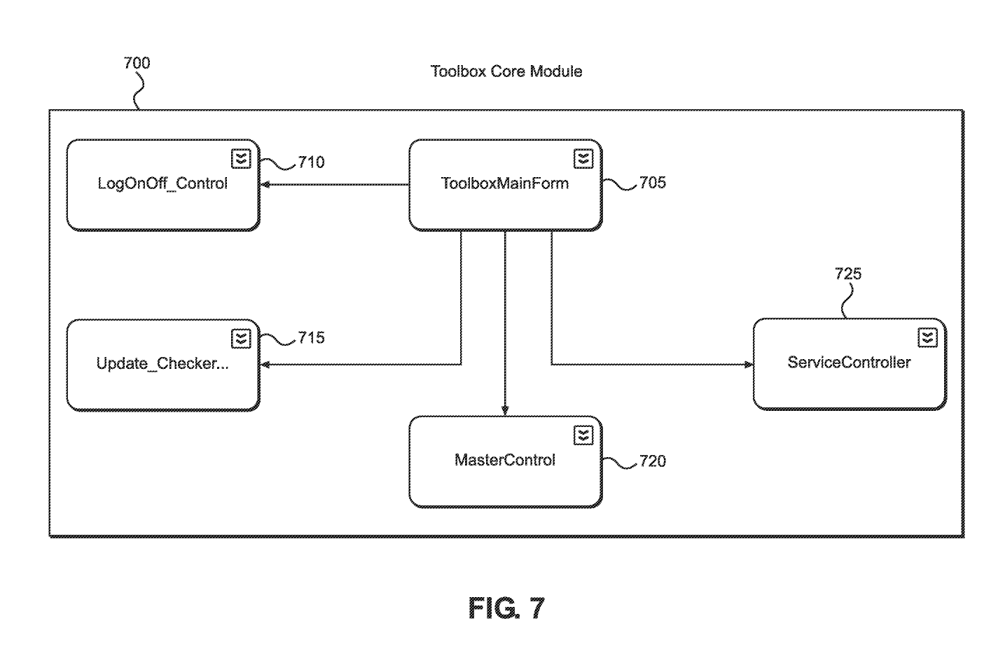

FIG. 7 shows the components of a toolbox core module 700 in a product testing and certification process. The relationships among and between the different elements of toolbox 500 for core module 700 are shown and include: (a) a mainform component 705 that is the central module of toolbox 500 and from which the other core modules are accessed; (b) a user login component 710 for permitting users to log in and log off of toolbox system 500 and to properly authenticate users to access toolbox 500; (c) an update checker 715 is accessed for checking for software updates to the toolbox application, and encrypting or decrypting any settings information such as connection strings; (d) a master control component 720 for setting default user information to be used by all other modules of toolbox 500; and (e) a service controller component 725 for communicating with the update service to download and install new versions when updates are available.

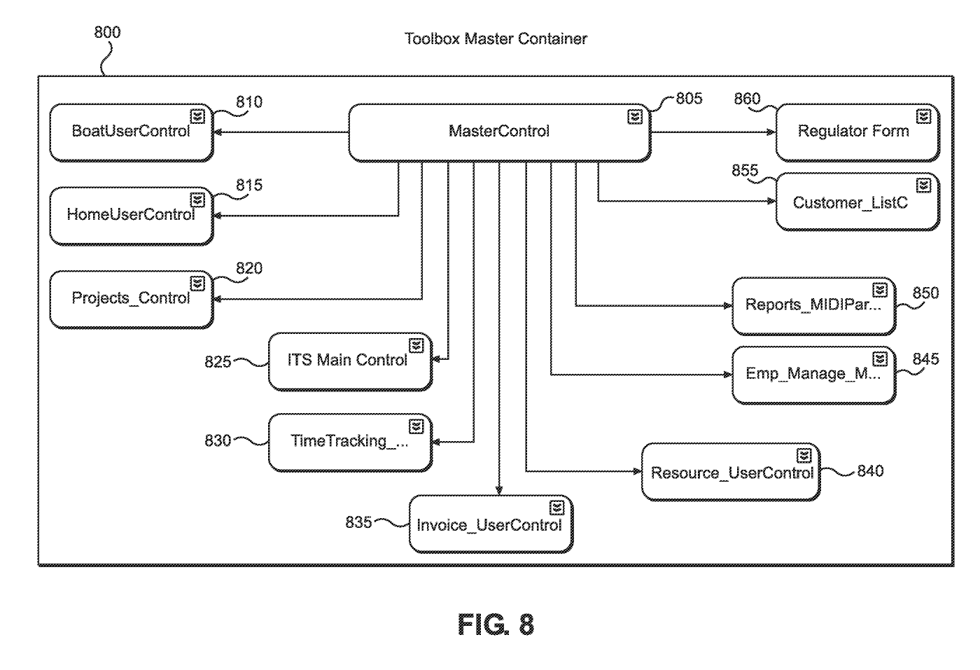

FIG. 8 shows the components of a toolbox master container module 800 of toolbox 500 in a product testing and certification process. The major relationships among and between the elements of master container 800 are shown. Master container 800 includes a master control component 805 at the center of master container 800 which initializes and loads all control libraries used by master container module 800. Control is provided after a user has been authenticated and master container module 800 determines which libraries should be loaded based on the user access level.

The libraries may vary in type and number. In the representative system of FIG. 8, several libraries are shown, including: (a) Boat User Control 810 which is accessed to manage the addition of new users and records to online approval technology module 530; (b) User Home Page Control 815 which is accessed to provide the customized dashboard to the user; (c) Project Management Control 820 which is accessed to manage all data entered and used by project management module 545; (d) ITS Main Control 825 which is accessed to manage all data entered into item tracking system module 550; (e) Time Tracking 830 which is accessed to track the time entered by one or more users; (f) Invoice Control 835 which is accessed to generate the invoice reports; (g) Resource Management Control 840 which is accessed to manage regulator profile information and customer data in the regulator management module 560 and business development module 570, respectively, and all contact information for both; (h) Employee Manager Control 845 which is accessed to manage all the employee profiles in the employee management module 565; (i) Reports Control 850 which is accessed to run and view toolbox reports; (j) Customer View Control 855 which is accessed to display a read-only list of customer profiles and (k) Regulator View 860 which is accessed to display a read-only list of regulator profiles. It should be understood that other components of master container module 800 may also be provided as new or alternative functionality is developed.

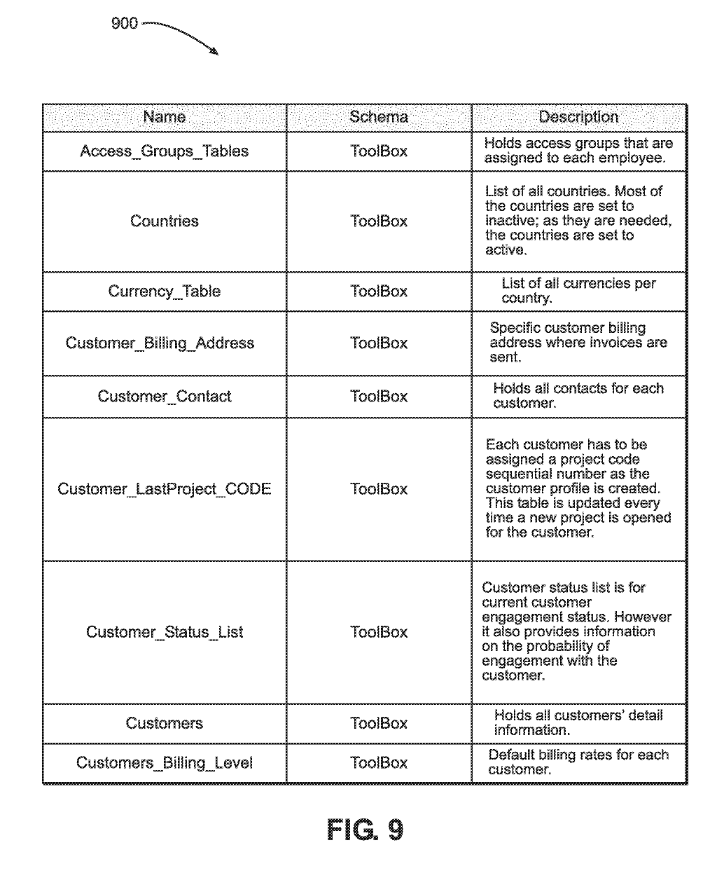

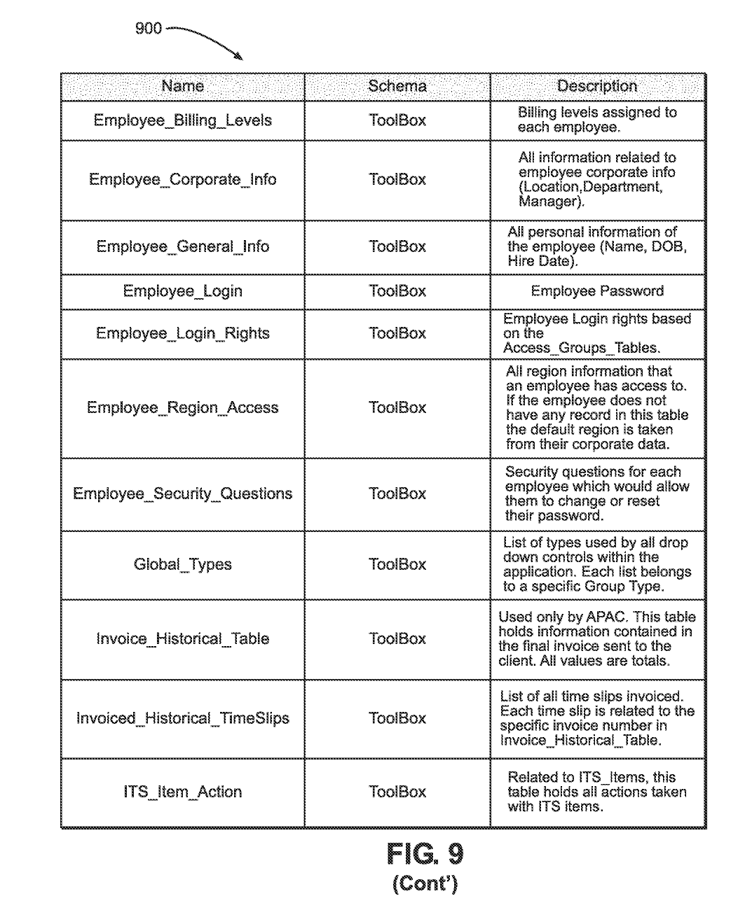

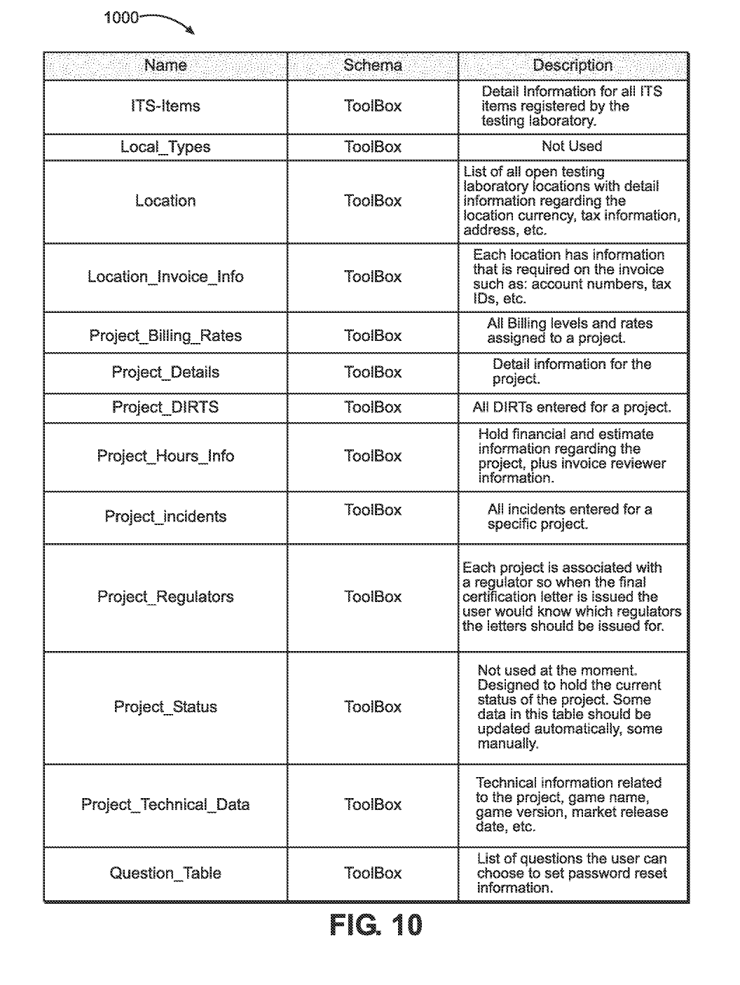

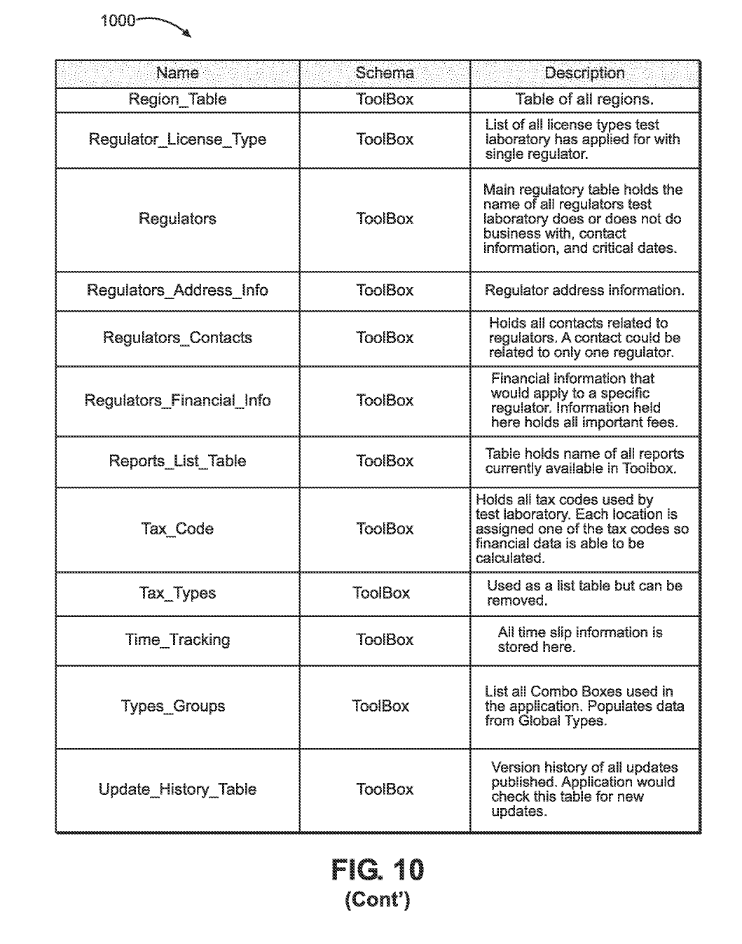

FIGS. 9-10 shows two parts 900, 1000 of a single representative listing of the major database files for Toolbox Central Database 505. The columns of tables 900, 1000 identify the name, schema and description of each database file. Database tables 900, 1000 are created by the developer to store the data used by the various toolbox modules. They are then accessed by toolbox 505 as part of the process for reading and writing data and to generate reports. Each entry may be edited and updated by authorized users of toolbox 505 when additions or updates are needed. It should be understood that the format and substance of the table in FIGS. 9-10 is shown as an example, but that it may be represented in any number of alternative formats and include more, less or alternative data that is of interest to the user.

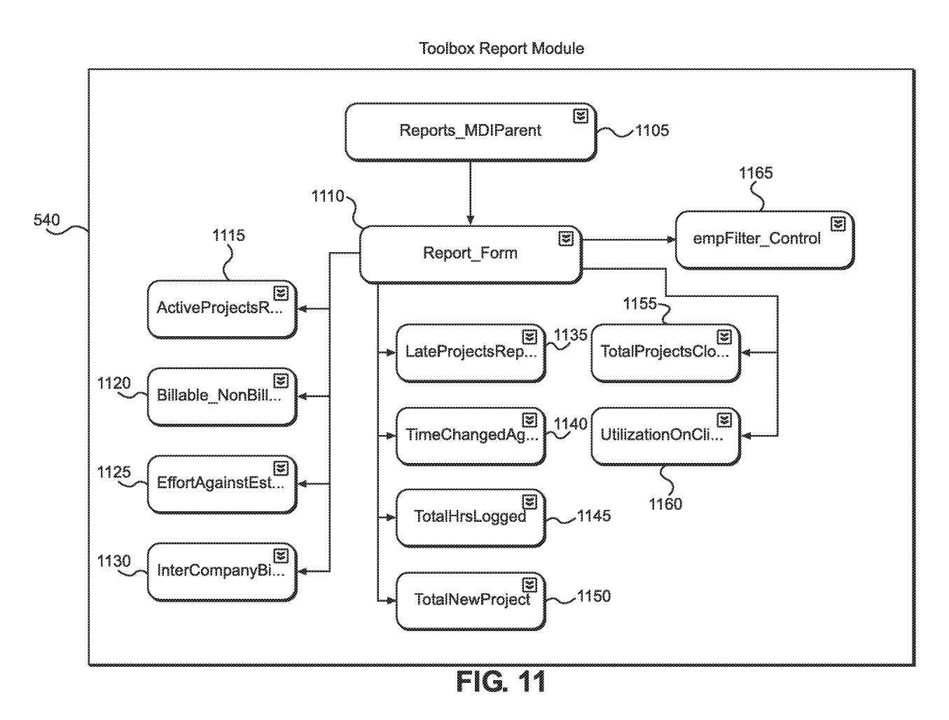

FIG. 11 shows the components of a toolbox report module 540 and the interrelationships among those components in a product testing and certification process. A report MDI Parent Class module 1105 is shown. A report form 1110 is generated by report parent 1105. A number of different representative reports are shown. For example, an active project report 1115 is used to show a detailed listing of all projects currently in process. It will be understood that a report of active projects may be further limited to particular users or clients. Another example of a report is a billable/non-billable report 1120. This report may include the billable and non-billable hours that have been logged for a particular client of the testing laboratory. Many other types of reports are also shown including an effort against estimates report 1125 to show an estimate of the billing for one or more projects and an inter-company billing report 1130 that details work performed by one location that is billed to the client by another location.

All reports in the report library are created as an independent class and loaded into the report form when requested. To ensure that the search requirements are met for each report, there is a class control that loads all search options for specific reports. Main control for this library is a form, which is separate from toolbox main form in order to create a flexible environment for the user to switch between different screens.

A number of other report types are also shown on FIG. 11 including a late project report 1135 that details a listing of late projects, a time charged against estimate report 1140 that details a listing of actual hours expended versus hours estimated for the project, a total hours logged report 1145 that details a listing of total hours logged for each listed project, a total new project report 1150 that details a listing of new projects added since a particular date, a total projects closed report 1155 that details a listing of closed projects for a specific date range and a utilization on client report 1160 that details a listing of utilization of resources such as billable and non-billable hours for each client. An employee filter control block 1165 is used to show that an employee of the testing laboratory may enter filtering information such as date range, location, employee or customer when running any of the reports. It should be understood that the report types shown in FIG. 11 are representative and exemplary for purposes of showing how the toolbox 540 may be used. It should be understood that other report forms may be generated and added to the library of forms accessible and usable through toolbox report module 540.

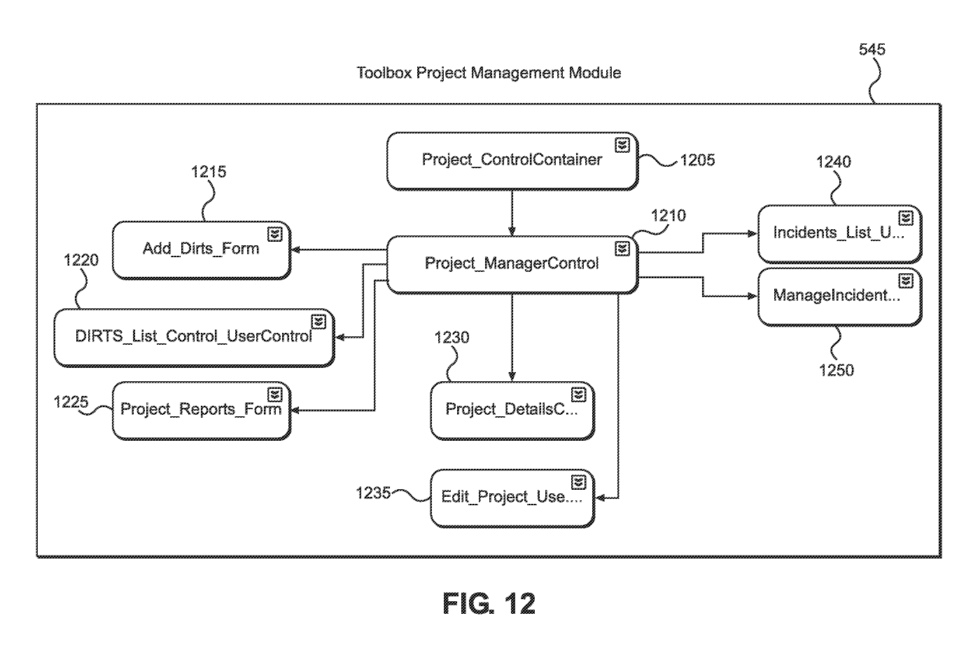

FIG. 12 shows the components of a toolbox project management module 545 and the interrelationships among those components in a product testing and certification process. Project management module 545 contains all controls related to project information. Control of the module is handled by projects control container 1205 which is the hub to all project information and related controls. The initial page loads all filters and lists all projects. Once loaded, a project manager control block 1210 accesses the project dashboard which provides the user with means to manage all aspects of a single project record. This control also contains a navigation tool with the following buttons: (a) add DIRT (“Defect Imperfections Reported during Testing”) form 1215, which allows the user to add detail on defects found during testing; (b) DIRT list control user control 1220 which displays the listing of all the DIRTs found and entered during testing of a particular project; (c) project reports form 1225 which provides an exportable format to Excel (or other spreadsheet applications) for all DIRTs and incidents found during testing on a particular project; (d) project details container 1230 which displays the data entered specific to the project including but not limited to customer name, billing contact, project code, priority, status, project type, project description and milestone dates; (e) edit project user control 1235 which allows the user to add or change data in project details container 1230; (f) incidents list user control 1240 which displays details on any incidents or events encountered during the lifecycle of the project; and (g) manage incidents form 1250 which allows the user to add or edit an incident record.

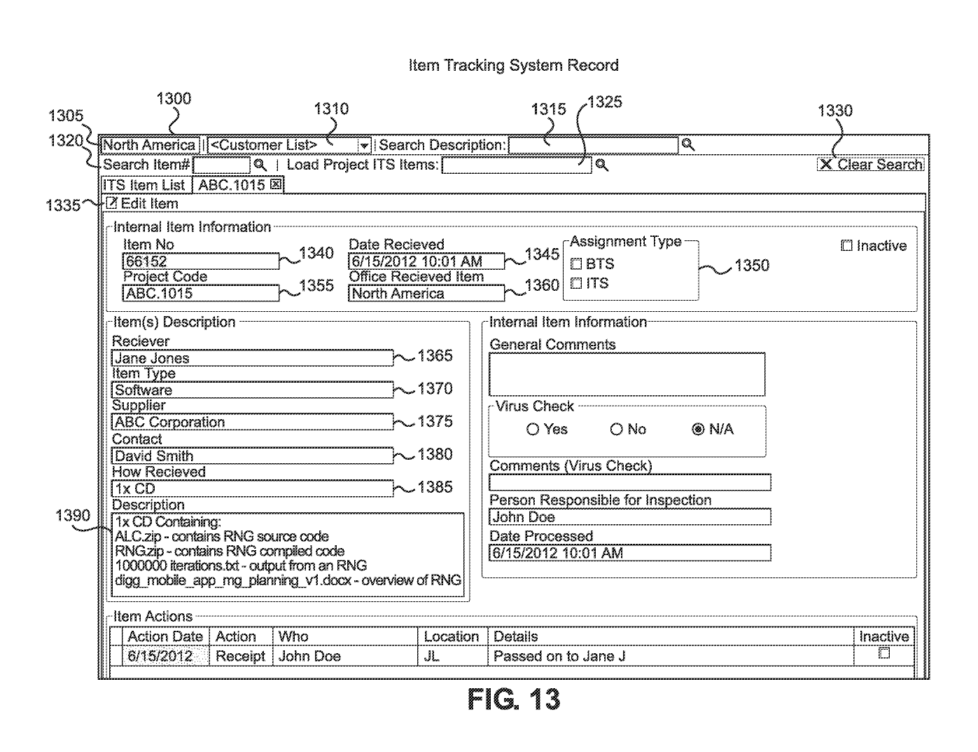

FIG. 13 shows a representative item tracking system record 1300 produced by the toolbox tracking module 550. Record 1300 shows the input fields required for toolbox item tracking system 550. It is possible to search for a particular record for the purpose of reviewing information in that record, or to edit that record. Search boxes include a drop down location box 1305 which shows North America as an entry, a filter box 1310 that may be used to search by customer within the location 1305 selected. A search description box 1315 is used to type in keywords that are used for record searching by customer 1310 and location 1305. A user may also search by item # in box 1320. The user may search by partial or full project code to list all items related to the specific project in load project item tracking system (“ITS”) 1325. A clear search button 1330 is used to clear the information from the search boxes so that a new search can be initiated. An ITS items list displays the ITS number that is being reviewed. Edit item button 1335 allows the user to make additions or changes to the inventory tracking system record.

As can be seen in FIG. 13, each record includes a variety of data including but not limited to an item number 1340, date received 1345, assignment type 1350 which in example record 1300 may be a business tracking system (“BTS”) project which categorizes hardware components that remain at the testing laboratory facility through multiple projects. Assignment type 1350 may also be an ITS project, which categorizes hardware and software for single project use. Other information may include a project code 1355 and a particular office where an item was received 1360, which may be presented in a drop down menu. A set of data describing the item is also included in record 1300. Examples of description data include but are not limited to the name 1365 of the receiver of the item, the item type 1370, the supplier 1375, a contact 1380, how it was received 1385 and a description of the item 1390. Other data in record 1300 relates to item processing and item actions which are self explanatory as shown in FIG. 13.

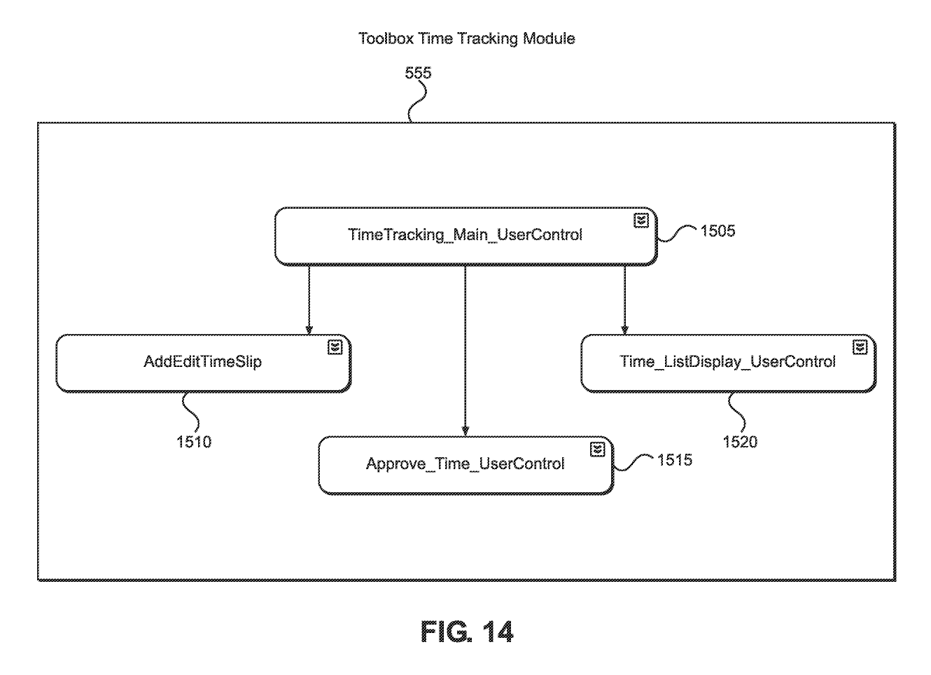

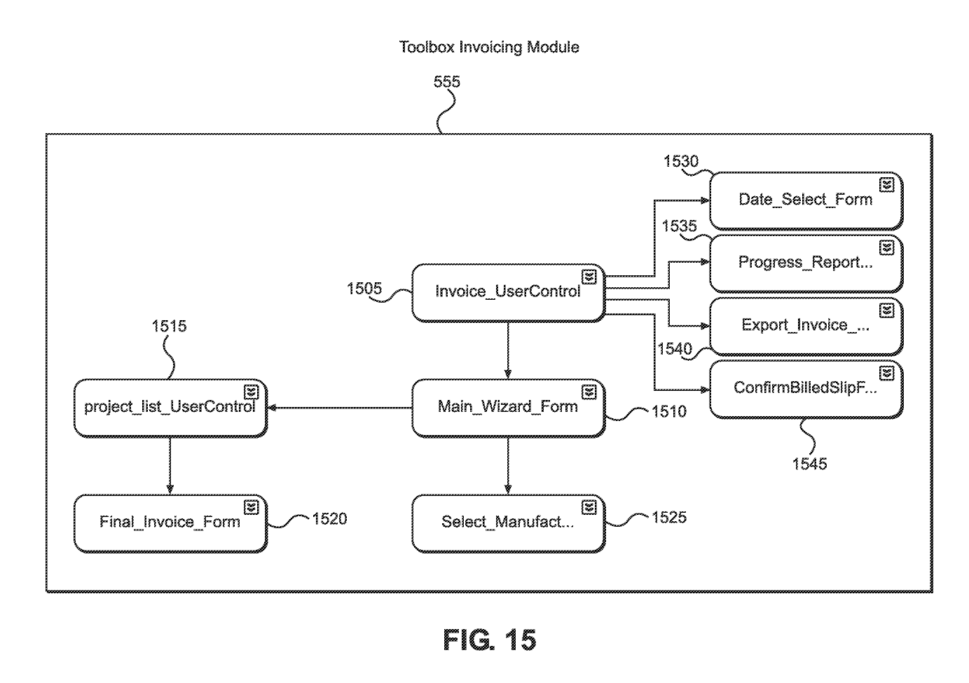

FIG. 14 shows the time tracking components of a toolbox time tracking module and invoicing module 555 in a product testing and certification process. There are two different stages of a time slip with the first being shown in FIG. 14 where time is tracked and a second being shown in FIG. 15 where time that has been tracked is invoiced. A time tracking main user control block 1505 controls time tracking. Control block 1505 calls add-edit time slip 1510 that enables a user to open a new time slip or edit an existing time slip. Approval of a time slip for invoicing is shown in block 1515 while block 1520 labeled time-list display shows an employee's time entered by project and client for a specified week and allows the user to access a specific time record for editing if required. The time slip first is entered into the system. It should be understood for purposes of time tracking that approval of a time slip for invoicing is only available to managers and the invoice reviewer. Other configurations of time tracking may be used including review by an employee with overall responsibility for a particular client of the testing laboratory.

FIG. 15 shows the time invoicing components of the toolbox time tracking module and invoicing module 555 in a product testing and certification process. An invoice user control block 1505 controls the invoicing function of tracking module and invoicing module 555. A default form 1510 (also referred to as Main Wizard Form) is provided and accessed by invoice user control block 1505. A project list user 1515 is used by the form to provide a list of projects that are ready to be invoiced and produces a final invoice form 1520. In addition, the form allows a manufacturer (client) to be selected to receive the invoice at block 1525. Control block 1505 sets up each invoice with a date selection 1530, a progress report 1535 which describes the current status of the project to which the invoice corresponds, an export to Excel (or another spreadsheet application) of the time reported on each of the customer projects listed on the invoice at block 1540 and a confirmation of the invoice at block 1545.

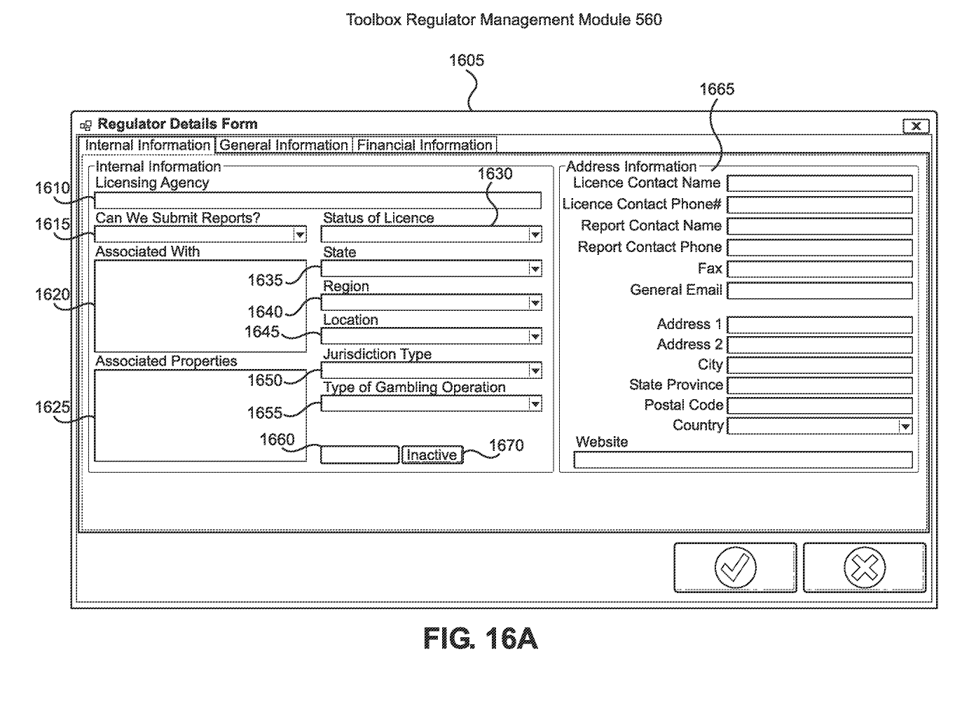

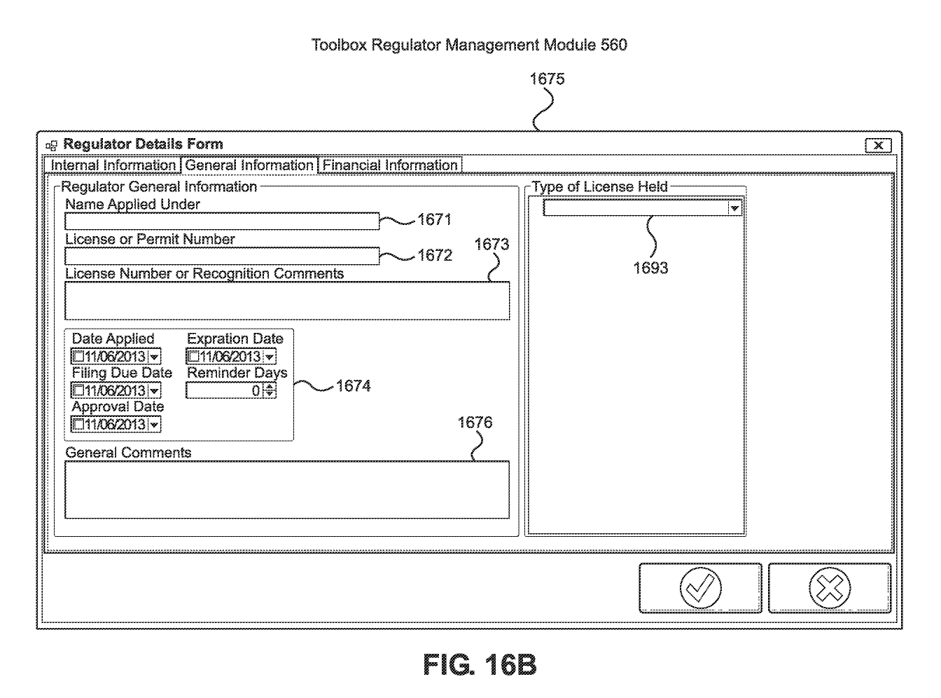

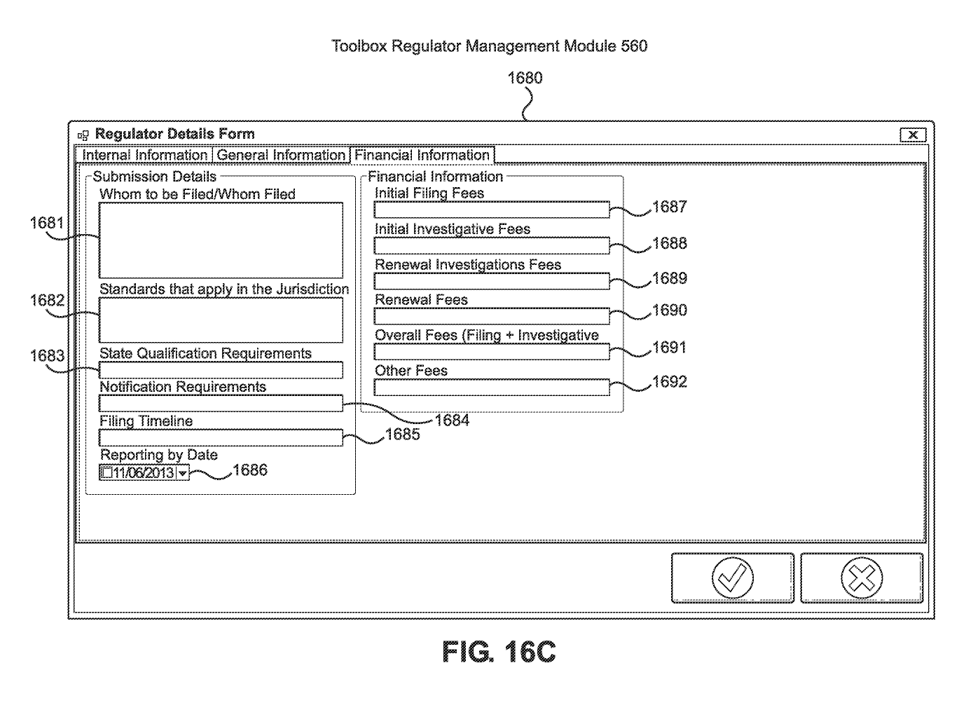

FIGS. 16A-16C show three representative records produced by the toolbox regulator management module 560 that are in a “stacked” tab form like that used in a typical spreadsheet that can be selected by the user: (a) internal information 1605; (b) general information 1670; and (c) financial information 1680. Internal information screen 1605 allows regulator data to be entered including: (1) the name 1610 of the licensing agency; (2) Can we submit reports 1615 which states whether or not the regulator accepts an independent testing laboratory's report, regardless of whether the client submits the report or if the testing laboratory submits it; (3) a list of other regulators or associations that this agency is associated with 1620; (4) properties that are controlled by this regulator are listed in associated properties 1625; (5) status of the testing laboratory's license with the agency is listed in status of license 1630; (6) the state 1635 in which the agency resides; (7) the testing laboratory region 1640 that the agency applies; (8) the testing laboratory location 1645 who tests and holds the license for this agency; (9) jurisdiction type 1650 that lists the type of regulator (tribal, state, government); (10) type of gambling operations 1655 allowed in the jurisdiction; and (11) contact information for the license 1665 such as contact name, phone number, email address and physical address of the licensing agency. In addition, there is a regulator ID 1660 that is used by the testing laboratory. The inactive button 1670 disables the record so it is not used by other parts of the toolbox system.

FIG. 16B shows the general information screen 1675 of the toolbox regulator management module 560 which allows the following data to be entered: (1) name applied under 1671 which identifies the testing laboratory entity used to apply for the license; (2) the license or permit number 1672 which has been issued to the testing laboratory by the regulatory agency; (3) license number or recognition comments 1673 which allows any additional comments regarding this particular license; (4) critical dates 1674 associated with this license including the date the license was applied for, the date all filings to the agency should be completed by, the date the testing laboratory received approval from the agency, the date the current license expires and the number of days before license expiration that the system notifies individuals that the renewal is due; (5) the types of licenses held 1693 that the testing laboratory holds with this regulatory agency and any additional general comments 1676 that pertain to this regulator or this license.

FIG. 16C shows the financial information screen 1680 which allows the following data to be entered: (1) whom to be filed/whom filed 1681 which lists all testing laboratory employees that hold licenses with this regulator; (2) standards that apply in the jurisdiction 1682 that lists the standards adopted by the regulator for use; (3) state qualification requirements 1683 which lists requirements that must be met in order to qualify for a license in this jurisdiction; (4) notification requirements 1684 that identifies any required notifications that the regulator may have of the testing laboratory; (5) filing timeline 1685 which provides information of the filing that needs to occur; (6) reporting by date 1686 which provides the date for any specific reporting that is required; (7) initial filing fees 1687 identifies the fees that the testing laboratory is required to pay to file for the license; (8) initial investigative fees 1688 identifies the fees that the testing laboratory is required to pay for the investigation the jurisdiction performs prior to issuing the license; (9) renewal investigation fees 1689 that identifies any investigative fees that the testing laboratory must pay to renew their license; (10) renewal fees 1690 that identifies any fees the testing laboratory has to pay to renew the license; (11) overall fees 1690 that automatically calculates the total amount it will cost to get the initial license; and (12) other fees 1692 that identifies any additional fees required.

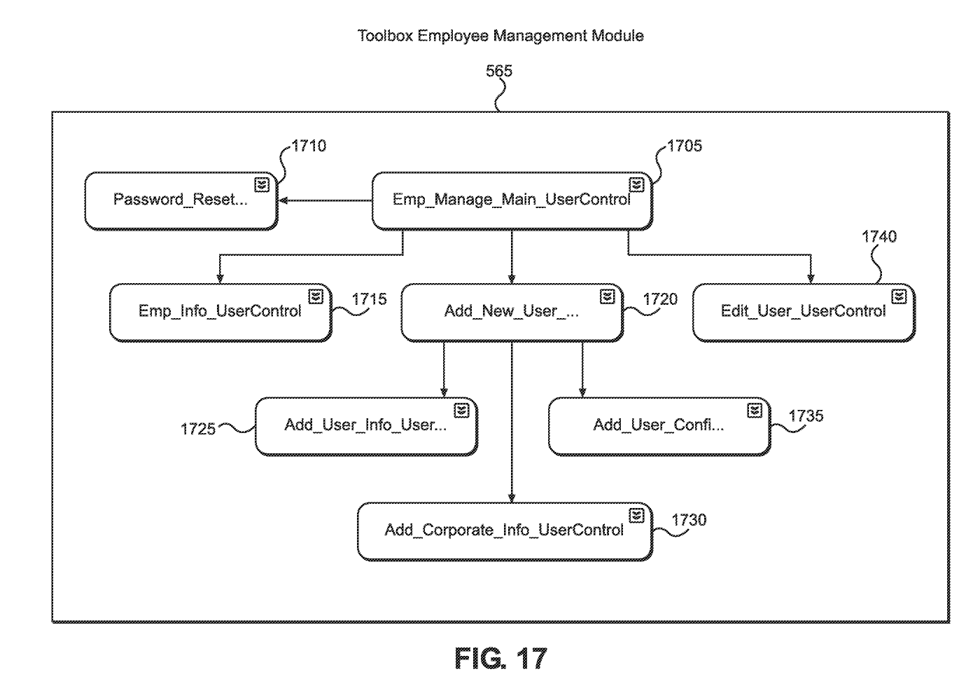

FIG. 17 shows the components of a toolbox employee management module 565 in a product testing and certification process, and the inter-relationships among and between these components. As described above, toolbox employee management module 565 manages employee user accounts and profiles. An employee management main user control block 1705 controls module 565. A password reset block 1710 is accessed by control block 1705 to reset a user password. Employee information user control 1715 displays the employee profile data that has been entered for a specific employee which includes name of the employee, address, personal phone numbers, date of birth, hire date, company email address, company contact information, billing levels, and other employee specific information. Add new user form 1720 allows the user to input the data that is reflected in employee information user control 1715. Add user information user control 1725, add corporate information user control 1730 and add user configuration 1735 are all accessed through add new user form 1720. Add user information user control 1725 allows input of employee specific data such as name, address, personal phone numbers, and date of birth. Add corporate information user control 1730 allows input of hire date, termination date, job title, department, manager, region, location and corporate contact information including email, office and mobile phone numbers and work address. Add user configuration 1735 allows the input of access levels including access to local and other region data, billing levels and various access levels. Edit-user user control 1740 allows changes to be made to the employee profile.

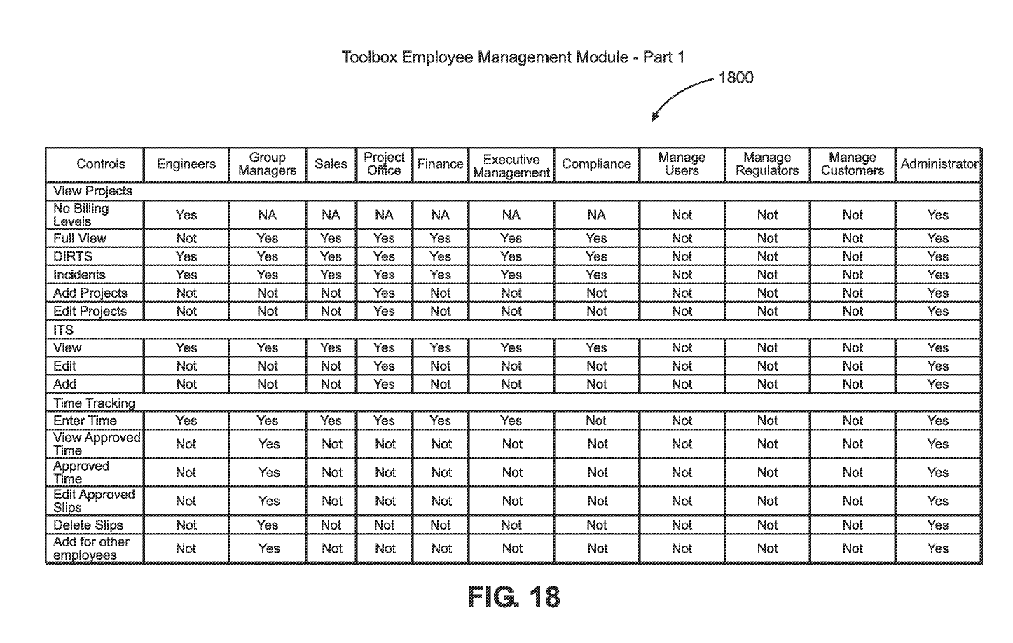

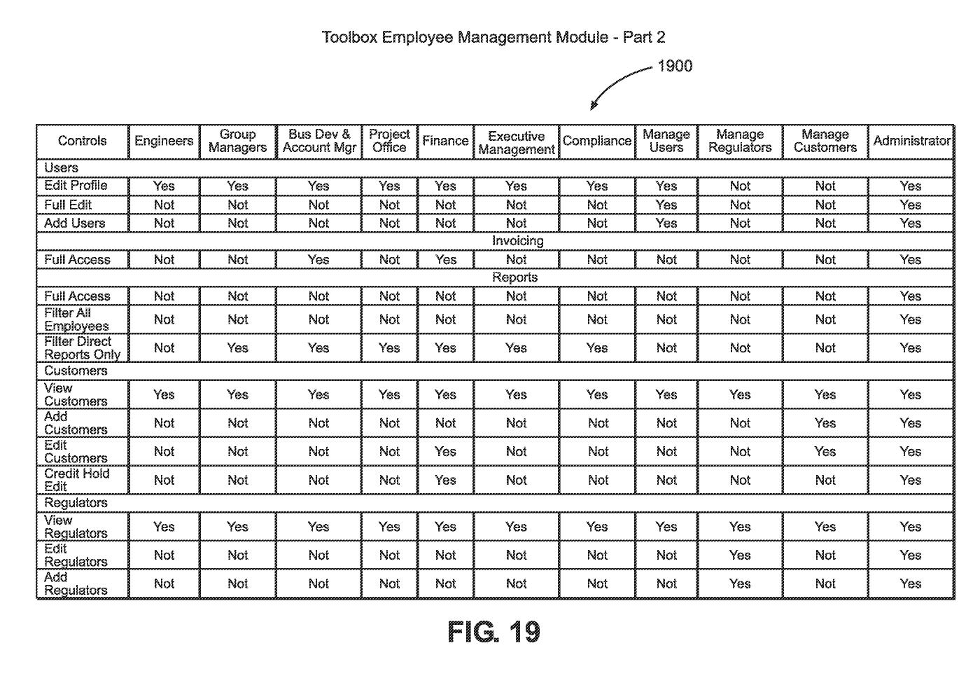

FIG. 18 and FIG. 19 are two parts of a representative listing 1800, 1900 of the major users of toolbox employee management module 565 showing the control parameters which provide users with the appropriate level of access based on the toolbox user categories. In the first part of the listing 1800 shown in FIG. 18, a list of “View Projects,” “ITS,” and “Time-Tracking,” are shown. In the second part of the listing 1900 shown in FIG. 19, a list of the “Users,” “Customers,” and “Regulators” are shown. The listing is in the form of a table with a variety of columns shown including: Controls, Engineers, Group Managers, Sales, Project Office, Finance, Executive Management, Compliance, Manage Users, Manage Regulators, Manage Customers, Administrator and/or Business Development and Account Manager. Each of these columns has information that is entered by users as identified by the access levels (column headings) and used for providing access to the controls listed on Column 1. As with the other tables and forms shown in the figures, this listing is a sample and is representative of a format in which the information can be shown. Alternative formats and substantive information may also be generated by the system and shown in a table format.

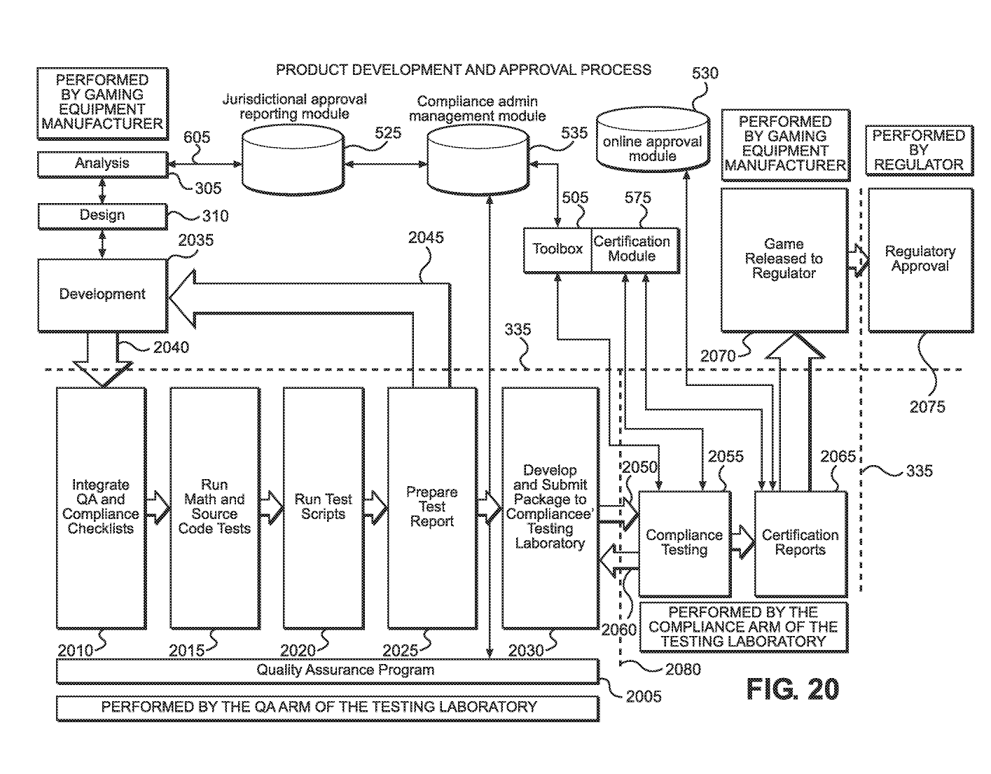

FIG. 20 shows a block diagram of an alternative embodiment for a new process to test and certify equipment for regulatory compliance and showing system components associated with the overall process. It should be understood that the system components are the same as those described with respect to FIGS. 5-6 and as such, those components have the same reference numbers. For a description of the operation of the system components, refer to the description of those components above.

In this embodiment, a separate, independent quality assurance arm of the testing laboratory actually performs and delivers all of the quality assurance steps 2010-2030 making up quality assurance block 2005. In a manner similar to the embodiment described above with respect to FIG. 6, the quality assurance step 2005 is made up of a group of substeps including integrating QA and compliance checklists 2010, running math and source code tests 2015, running test scripts 2020, preparing test reports 2025, and developing and submitting a package to the compliance testing laboratory 2030. Instead of being performed by the manufacturer, the testing laboratory is contracted to perform quality assurance and the work is performed by a separate arm of testing laboratory. It is important to note that the independent quality assurance arm of the testing laboratory is a completely separate entity, both organizationally and physically, from the compliance testing laboratory. This quality assurance team receives software from the client development team at step 2035 as indicated by arrow 2040. While there is testing performed by the gaming equipment manufacturer throughout the development cycle, the final quality assurance (“QA”) testing performed by the QA arm of the testing laboratory is conducted once a release build (which is a pre-release version of a software program or product that is ready to enter the quality assurance testing phase) has been completed and prior to a certification build (which is a pre-release version of a software program or product that has passed the QA testing phase and is ready to enter the compliance testing phase) is being submitted to a compliance testing laboratory for testing. The release build may be made up of various component pieces that may already have been tested by the QA arm of the testing laboratory, The QA arm of the testing laboratory will run the release build of the product through QA testing substeps 2010-2030 and provide a QA test report back to the manufacturer's development team at step 2045 that describes what defects were found during testing.

The development team makes changes to the software based on the QA test report and provides a new software version to the testing laboratory QA team for testing. The QA arm and the manufacturer continue to refine development and test the different software versions until a release build satisfies the testing laboratory's independent QA arm. As a part of the QA testing performed by the separate QA arm of the testing laboratory, pre-certification tests are run on the release builds, thereby finding technical and regulatory problems at the earliest possible time and lowest cost to the gaming equipment manufacturer. In addition, the QA arm of the testing laboratory will have access to all the tools available to the testing laboratory and benefit from the use of these tools when performing their QA pre-certification testing. The QA teams of the testing laboratory will not be involved with the certification testing at all. The compliance arm of the testing laboratory will conduct independent certification testing once the QA process has been completed. A dashed line 2080 shows the separation between the QA arm of the testing laboratory and the compliance arm of the testing laboratory.

At this point, the certification build is passed through to the compliance arm at arrow 2050. Compliance testing is performed at 2055 by the compliance arm and if any defects are found, which should be unlikely at this point given that QA has completed its work, the compliance arm prepares a report and sends it to the QA arm for review at arrow 2060. Any changes required in the product are then communicated to by the QA arm of the testing laboratory to the manufacturer at arrow 2045 which revises the product and sends it back through QA again at arrow 2040. If the product makes it through the QA substeps 2010-2030 and compliance testing 2055 without further issues, a certification report is provided at step 2065 and the product is released by the manufacturer to the regulators at step 2070. Regulatory approval follows at step 2075 and is issued by the regulators.

The QA arm of the testing laboratory performs all areas of QA. The types of QA testing to be performed by the QA arm of the test lab at steps 2015 and 2020 includes, but is not limited to the following tests:

Functional testing: Testing is performed to verify a specific action or function of software code or hardware operations. For software, the functions to be tested are usually found in the code requirements documentation, although some development methodologies work from use cases or user stories. Functional tests tend to answer the question of “can the user do this” or “does this particular feature work.”

Acceptance testing: Testing is performed to test the system that is delivered to the user for Acceptance testing. Acceptance testing is testing by the end user of the software that verifies the software works as desired. This is one of the final stages of a project before the customer accepts the new system or software project.

System testing: Testing is performed on a completely integrated system to verify that it meets all requirements.

Installation testing: Testing is performed to assure that the system is installed correctly and working on all targeted hardware.

Compatibility testing: Testing is performed on the application to evaluate the application's compatibility with the computing environment (CPU, memory, hard drives, etc).

Pre-Compliance Testing: Testing is performed to determine if a system meets regulatory standards.

Smoke testing: Testing is performed to determine whether there are serious problems with a new build or release. Smoke testing is an acceptance test that occurs prior to introducing a build to the main testing process.

Sanity testing: Testing is performed to determine whether it is reasonable to proceed with further testing. Sanity testing is a brief run through of the software's functionality that indicates that the product works as expected.

Regression testing: Testing is performed focusing on finding defects after a major code change has occurred. Specifically, it seeks to uncover previously existing bugs that remain hidden in the code.

Destructive testing: Testing is performed to identify the cause of a software or a sub-system failure.

Performance testing (load & stress): Testing is performed to determine how a system or sub-system performs in terms of responsiveness and stability under a particular workload. It can also serve to investigate, measure, validate or verify other quality attributes of the system, such as scalability, reliability and resource usage.

Usability testing: Testing is performed to check if the user interface is easy to use and understand. It is concerned mainly with the use of the application.

Security & Penetration testing: Testing is performed on software that processes confidential data to ensure privacy and to prevent system intrusion by hackers.

Globalization (Internationalization) testing: Testing is performed to verify the functional support for a particular culture/locale including different languages, regional differences and technical requirements for a specific market.

Localization testing: Testing is performed to translate the product user interface and may change some initial settings to make it suitable for another region/locale. Localization testing checks the quality of a product's localization for a particular target culture/locale.

Integration or API testing: Testing is performed on the software to verify the interfaces between components against a software design.

Automation testing: Testing is in the form of the creation and use of software, separate from the software being tested, to control the execution of tests and the comparison of actual outcomes to predicted outcomes.

Dev testing: Testing is performed that involves synchronized application of a broad spectrum of defect prevention and detection strategies in order to reduce software development risks, time, and costs. It is performed by the QA engineer during the construction phase of the software development lifecycle.

Black box testing: Testing is performed that treats the software as a “black box”, examining functionality without any knowledge of the internal source code.

White box testing: Testing is performed to test internal structures or workings of a program, as opposed to the functionality exposed to the end-user. In white-box testing an internal perspective of the system, as well as programming skills, are used to design test cases.

Gray box testing: Testing is performed involving having knowledge of internal data structures and algorithms for purposes of designing tests, while executing those tests at the user, or black-box level.

Managed services: Testing is performed to test the practice of outsourcing day-to-day management responsibilities as a strategic method for improving operations and cutting expenses.

Outsourcing: Contracting out of a business process to a third-party.

QA Governance: A subset discipline of corporate governance focused on QA systems and their performance and risk management.

While the invention has been described with respect to the figures, it will be appreciated that many modifications and changes may be made by those skilled in the art without departing from the spirit of the invention. Any variation and derivation from the above description and drawings are included in the scope of the present invention as defined by the claims.

What is claimed is:

1. A system for testing and approving equipment for regulatory compliance that is accessible over a network by an equipment manufacturer and a testing laboratory:
a server for hosting the system on a network including an interface to the system for use by employees, clients and regulators;
a client database accessible by the server to store product data associated with one or more clients;
a regulatory database accessible by the server to store compliance data associated with one or more client products for one or more jurisdictions; and
a database having at least one integrated checklist for use by the equipment manufacturer and the testing laboratory wherein the integrated checklist provides a set of testing requirements each of which is to be assessed by one or both of the equipment manufacturer and the testing laboratory and further wherein a set of quality assurance (“QA”) and compliance test results recorded by the equipment manufacturer that are applicable to particular equipment of the manufacturer are accessible by both the equipment manufacturer and the testing laboratory.

2. The system of claim 1 further comprising a jurisdictional approval reporting module for submitting projects to a testing laboratory, and tracking and managing those projects through regulatory approval.

3. The system of claim 1 further comprising a compliance administration management module for supporting technical compliance by maintaining a database of regulatory requirements and testing laboratory checklists.

4. The system of claim 1 further comprising an online approval module for storing and maintaining updated data records from at least one of the types in the group including: a) certification letters; b) recommendation letters; c) evaluation reports; d) regulatory approvals; e) revocations; and f) field verifications.

5. The system of claim 1 further comprising a report module for reporting project metrics including data records from at least one of the types in the group including: a) estimated costs; b) actual costs; and c) time charged.

6. The system of claim 1 further comprising a project management module for controlling project data and accessible by users to add, delete and edit project data to record and track project progress.

7. The system of claim 1 further comprising an item tracking module for storing and tracking data related to a sample product or component received and the location and any actions taken with respect to that sample product or component.

8. The system of claim 1 further comprising a time tracking module for storing and tracking data related to time required for testing laboratory personnel and expenses associated with a particular project.

9. The system of claim 8 further comprising an invoicing module for retrieving data from the time tracking module, using the data to generate an invoice, and providing internal testing laboratory metrics based on one or more factors in the group consisting of: a) costs; b) productivity; c) cycle time; and d) quality.

10. The system of claim 1 further comprising a regulator management module that stores and tracks third party regulatory contact and licensing data including at least one of the data types from the group consisting of: a) licensing fees; b) status of a license; and c) renewal dates.

11. The system of claim 1 further comprising an employee management module for managing testing laboratory employee data related to user accounts, access levels and billing information.

12. The system of claim 1 further comprising a business development module for managing current and potential business opportunities being pursued by a testing laboratory.

13. The system of claim 1 further comprising a certification report module for providing product assessment and certification reports and transfer letters for cross-jurisdictional approvals between one regulatory agency and another.

14. The system of claim 1 further comprising a regulatory export services module for use by regulators to receive scheduled exports of project related certification report data.

15. The system of claim 1 wherein an equipment manufacturer uses the system through a subscription service with fees paid at recurring intervals.

16. A method to test and certify a product for regulatory compliance using a networked system operated by a testing laboratory that runs a project management module and includes a database for capturing and maintaining data for projects related to the product, the system being accessible by the testing laboratory and a client on the network, wherein:
(A) accessing the system through a client portal to complete a quality assurance checklist for the product that includes product information from the group of information types that includes one or more of: i) name; ii) product type; iii) product description; and iv) product requirement;
(B) performing product testing by the client on the product to produce client test data;
(C) recording the client test data in the database;
(D) executing a checklist of test scripts to ensure all tests needed to prove regulatory requirements compliance as set forth by the jurisdictions are captured on the checklists to be executed;
(E) recording test data in the database;
(F) accessing and evaluating the client test data by the testing laboratory;
(G) providing feedback from the testing laboratory to the client related to the client test data; and
(H) preparing a test report for the product based on one or more of a comparison between the client test data and performance requirements data; wherein the test report is one of either: (i) a satisfactory report indicating that the product meets minimum standards; or (ii) an unsatisfactory report indicating that the product requires modification to meet minimum standards, wherein an unsatisfactory report results in modifications to the product by the client and the client returning to step (A);
(J) developing a submission package based on the satisfactory report for the product; and
(K) submitting the submission package to the testing laboratory through the system for independent testing by the testing laboratory of the product.

17. The method of claim 16 wherein product testing by the client includes performing tests of one or more of the types including: a) mathematical models, b) source code, c) prototype testing, d) software testing, e) release builds, and f) certification builds.

18. The method of claim 16 further comprising reporting the test results to a third party responsible for granting final approval for deployment of the particular equipment.

19. The method of claim 16 further comprising maintaining and updating a database of regulatory requirements and testing laboratory checklists.

20. The method of claim 16 further comprising maintaining and updating a database of records from at least one of the types in the group including: a) certification letters; b) recommendation letters; c) evaluation reports; d) regulatory approvals; e) revocations; and f) field verifications.

21. The method of claim 16 further comprising reporting project metrics including data records from at least one of the types in the group including: a) estimated costs; b) actual costs; and c) time charged.

22. The method of claim 16 further comprising controlling project data to add, delete and edit project data to record and track project progress.

23. The method of claim 16 further comprising storing and tracking data related to a sample product or component received and the location and any actions taken with respect to that sample product or component.

24. The method of claim 16 further comprising storing and tracking data related to time required for testing laboratory personnel and expenses associated with a particular project.

25. The method of claim 24 further comprising retrieving data related to time required for testing laboratory personnel and expense, and using the data to generate an invoice and providing internal testing laboratory metrics on one or more factors in the group consisting of: a) costs; b) productivity; c) cycle time; and d) quality.

26. The method of claim 16 further comprising storing and tracking third party regulatory contact and licensing data including at least one of the data types from the group consisting of: a) licensing fees; b) status of a license; and c) renewal dates.

27. The method of claim 16 further comprising managing testing laboratory employee data related to user accounts, access levels and billing information.

28. The method of claim 16 further comprising managing current and potential business opportunities being pursued by a testing laboratory.

29. The method of claim 16 further comprising providing product assessment and certification reports and transfer letters for cross-jurisdictional approvals between one regulatory agency and another.

30. The method of claim 16 further comprising scheduling exports of project related certification report data to a third party regulatory agency.

31. The method of claim 16 further comprising the step of an equipment manufacturer using the system through a subscription service with fees paid at recurring intervals.
